(19) United States
(12) Patent Application Publication
(10) Pub. No.: US 2023/0191730 A1
(43) Pub. Date: Jun. 22, 2023

(54) APPARATUS, SYSTEMS, AND METHODS OF FORMING OPHTHALMIC LENS COMPONENTS WITH SOLUBLE CORES AND MOLDS

(71) Applicant: Alcon Inc., Fribourg (CH)

(72) Inventors: Andrew R. WALZ, Longmont, CO (US); Sharad HAJELA, San Carlos, CA (US); Gregory Vinton MATTHEWS, San Francisco, CA (US)

(73) Assignee: Alcon Inc., Fribourg (CH)

(21) Appl. No.: 18/067,165

(22) Filed: Dec. 16, 2022

Related U.S. Application Data
(60) Provisional application No. 63/265,735, filed on Dec. 20, 2021.

(51) Int. Cl. B29D 11/00

(52) U.S. Cl. CPC B29D 11/00057; B29D 11/00134; B29L 2011/0041

(57) ABSTRACT

Disclosed are methods, systems, and apparatus for manufacturing an ophthalmic lens component. In one embodiment, a method includes placing at least part of a soluble core component on a first molding surface of a first mold component or a second molding surface of a second mold component, mating the second mold component to the first mold component to form an assembled mold comprising a mold cavity, introducing a lens component material into the mold cavity, curing the lens component material within the assembled mold to form a molded lens component, and immersing the molded lens component in a solvent to dissolve the soluble core component. At least one of the first mold component and the second mold component can also be made of a soluble material.

### CROSS-REFERENCE TO RELATED APPLICATION

This application claims the benefit of U.S. Provisional Application No. 63/265,735 filed on Dec. 20, 2021, the entirety of which is incorporated herein by reference.

### TECHNICAL FIELD

The present disclosure relates generally to the field of ophthalmic devices, and, more specifically, to apparatus, systems, and methods of forming ophthalmic lens components with soluble cores and molds.

### BACKGROUND

A cataract is a condition involving the clouding over of the normally clear lens of a patient’s eye. Cataracts occur as a result of aging, hereditary factors, trauma, inflammation, metabolic disorders, or exposure to radiation. Age-related cataract is the most common type of cataracts. In treating a cataract, the surgeon removes the crystalline lens matrix from the patient’s lens capsule and replaces it with an intraocular lens (IOL). Traditional IOLs provide one or more selected focal lengths that allow the patient to have distance vision. However, after cataract surgery, patients with traditional IOLs often require glasses or other corrective eyewear for certain activities since the eye can no longer undertake accommodation (or change its optical power) to maintain a clear image of an object or focus on an object as its distance varies.

Newer IOLs such as accommodating IOLs, allow the eye to regain at least some focusing ability. Accommodating IOLs (AIOLs) use forces available in the eye to change some portion of the optical system in order to refocus the eye on distant or near targets. Examples of AIOLs are discussed in the following U.S. patent publications: U.S. Pat. Pub. No. 2018/0256315; U.S. Pat. Pub. No. 2018/0153682; and U.S. Pat. Pub. No. 2017/0049561 and in the following issued U.S. Pats: U.S. Pat. No. 10,299,913; U.S. Pat. No. 10,195,020; and U.S. Pat. No. 8,968,396, the contents of which are incorporated herein by reference in their entireties.

Traditional ophthalmic lenses are often made using molding techniques that rely on a polished mold having a mold cavity formed in the shape of the lens. Common molding techniques include injection molding, liquid injection molding, compression molding, and transfer molding. However, unlike traditional ophthalmic lenses, AIOLs are often made of components that comprise cavities or conduits for holding or carrying a fluid. In some cases, AIOL components, such as AIOL haptics, have been molded using solid inserts that are carefully pulled out of the molded haptic after the curing process. Such a step is labor-intensive and difficult to scale. Moreover, solid inserts often cannot be used for AIOL components with cavities or conduits having complicated shapes or geometries. This is especially true for AIOL components with cavities having multiple interconnected compartments or portions.

In addition, traditional molding techniques often leave small gaps between mold components during the molding process. As a result, material introduced into the mold often seeps or flows out of these small gaps and form visible lines or surface imperfections along the surface of the lens component (often referred to as “flash”). These flash lines or imperfections must be subsequently smoothed or polished off, thereby adding to the manufacturing time.

Therefore, a solution is needed which allows for ophthalmic lens components to be formed with cavities or conduits having complicated shapes or geometries. Such a solution should not be overly complicated and allow the lens components to be cost-effectively manufactured.

### SUMMARY

Disclosed herein are apparatus, systems, and methods of forming ophthalmic lens components (e.g., haptics or optic portions) with soluble cores and molds. In one embodiment, a method of manufacturing a lens component comprises providing a first mold component comprising a first molding surface defined by a first partial component cavity and providing a second mold component comprising a second molding surface defined by a second partial component cavity. The method can comprise placing at least part of a soluble core component on either the first molding surface or the second molding surface.

In some embodiments, placing at least part of the soluble core component on either the first molding surface or the second molding surface can comprise placing at least one positioning piece of the soluble core component on the first molding surface or the second molding surface. The at least one positioning piece can be at one end of the soluble core component. Another portion or segment of the soluble core component can be positioned over the first molding surface or the second molding surface but not be in physical contact with the first molding surface or the second molding surface. In other embodiments, a remainder of the soluble core component coupled to the positioning piece can be positioned over the first molding surface or the second molding surface but not be in physical contact with the first molding surface or the second molding surface.

The method can also comprise mating the second mold component to the first mold component to form an assembled mold. The second mold component can comprise the second molding surface defined by a second partial component cavity. A segment of the soluble core component can be disposed within a component mold cavity formed by the first partial component cavity and the second partial component cavity. Another segment of the soluble core component can be disposed outside of the component mold cavity when the second mold component is mated to the first mold component.

The method can also comprise introducing a lens component material into the component mold cavity and curing the lens component material within the assembled mold to form a molded lens component. The method can also comprise separating the first mold component from the second mold component after curing the lens component material to form the molded lens component. The method can further comprise removing the molded lens component from the first mold component or the second mold component. At least a segment of the soluble core component can be within the molded lens component when the molded lens component is removed from at least one of the first mold component and the second mold component.

The method can also comprise immersing the molded lens component in a solvent to dissolve the soluble core component. In some embodiments, the soluble core component can be made in part of polyvinyl alcohol. In these and other embodiments, the solvent can be water. The method can also comprise heating the solvent and agitating the solvent by sonication to expedite the dissolution of the soluble core component.

In some embodiments, the first molding surface can be further defined by a first partial plug cavity connected to the first partial component cavity. In these embodiments, the second molding surface can be defined by a second partial plug cavity connected to the second partial component cavity. Moreover, in these embodiments, the method can comprise placing a soluble plug within the first partial plug cavity or the second partial plug cavity prior to forming the assembled mold. The soluble plug can occupy a plug receiving space formed by the first partial plug cavity and the second partial plug cavity when the second mold component is mated to the first mold component. The method can further comprise curing the lens component material within the assembled mold when the assembled mold also comprises the soluble plug.

The method can also comprise removing the molded lens component and the soluble plug from the first mold component or the second mold component. The method can further comprise immersing the molded lens component and the soluble plug in the solvent to dissolve the soluble core component and the soluble plug. The soluble plug can be configured to prevent flash around a periphery of the molded lens component.

In some embodiments, the lens component can be a haptic of a lens and a haptic chamber can be formed within the haptic when the soluble core component is dissolved. In other embodiments, the lens component can be an optic portion of a lens and an optic chamber can be formed within the optic portion when the soluble core component is dissolved. In additional embodiments, the lens component can be part of an optic portion of a lens (e.g., an anterior lens element or a posterior lens element) and at least part of an optic chamber can be formed when the soluble core component is dissolved.

A system for manufacturing a lens component is also disclosed. The system can comprise a first mold component comprising a first molding surface defined by a first partial component cavity and a second mold component comprising a second molding surface defined by a second partial component cavity. The system can also comprise a soluble core component configured to be placed on the first molding surface or the second molding surface.

The soluble core component can include at least one positioning piece. The at least one positioning piece can be configured to be placed on either the first molding surface or the second molding surface. The at least one positioning piece can be at one end of the soluble core component. Another portion or segment of the soluble core component can be positioned over the first molding surface or the second molding surface but not be in physical contact with the first molding surface or the second molding surface. In other embodiments, a remainder of the soluble core component coupled to the positioning piece can be positioned over the first molding surface or the second molding surface but not be in physical contact with the first molding surface or the second molding surface.

The first mold component can be configured to be mated to the second mold component to form an assembled mold. A segment or portion of the soluble core component can be configured to be disposed within a component mold cavity formed by the first partial component cavity and the second partial component cavity when the first mold component is mated to the second mold component.

The component mold cavity within the assembled mold can receive a lens component material for curing into a molded lens component. The lens component material can be cured within the assembled mold into the molded lens component. The molded lens component can be removed from the first mold component or the second mold component when the first mold component is separated from the second mold component after curing. At least a segment of the soluble core component can be within the molded lens component when the molded lens component is removed from the at least one of the first mold component and the second mold component.

The soluble core component can be configured to be dissolved in a solvent when the molded lens component is immersed in the solvent. In some embodiments, the soluble core component can be made in part of polyvinyl alcohol. In these and other embodiments, the solvent can be water.

In some embodiments, the system can also comprise a heated water bath configured to heat the solvent when the molded lens component is immersed in the solvent. The system can also comprise a sonication device configured to agitate the solvent to expedite the dissolution of the soluble core component.

The system can further comprise a soluble plug configured to be placed within a first partial plug cavity defined along the first molding surface or placed within a second partial plug cavity defined along the second molding surface prior to forming the assembled mold. The soluble plug can be configured to occupy a plug receiving space formed by the first partial plug cavity and the second partial plug cavity when the second mold component is mated to the first mold component. The assembled mold comprising the lens component material, the soluble core component, and the soluble plug can be cured together.

After the curing step, the molded lens component comprising the soluble core component and the soluble plug can be removed from the first mold component or the second mold component to be immersed in the solvent.

The soluble core component and the soluble plug can be configured to be dissolved when immersed in the solvent. The soluble plug can be configured to prevent flash around a periphery of the molded lens component.

In some embodiments, the lens component can be a haptic of a lens (e.g., IOL or AIOL). In these embodiments, a haptic chamber can be formed within the haptic when the soluble core component is dissolved by the solvent.

In other embodiments, the lens component can be an optic portion of a lens. In these embodiments, an optic chamber can be formed within the optic portion when the soluble core component is dissolved by the solvent. Moreover, the lens component can also be part of an optic portion of a lens. At least part of an optic chamber can be formed when the soluble core component is dissolved by the solvent.

Another method of manufacturing a lens component is also disclosed. The method comprises providing a first mold component made of a soluble material. The first mold component can comprise a first molding surface defined by a first partial component cavity. The method can further comprise providing a second mold component made of a soluble material. The second mold component can comprise a second molding surface defined by a second partial component cavity.

The method can also comprise placing at least part of a soluble core component made of a soluble material on the first molding surface or the second molding surface and mating the second mold component to the first mold component to form an assembled mold. A segment of the soluble core component can be disposed within a component mold cavity formed by the first partial component cavity and the second partial component cavity when the first mold component is mated to the second mold component.

In some embodiments, placing at least part of the soluble core component on the first molding surface or the second molding surface can comprise placing at least one positioning piece of the soluble core component on the first molding surface or the second molding surface. The at least one positioning piece can be at one end of the soluble core component. Another portion or segment of the soluble core component can be positioned over the first molding surface or over the second molding surface but not be in physical contact with the first molding surface or over the second molding surface. In other embodiments, a remainder of the soluble core component coupled to the positioning piece can be positioned over the first molding surface or the second molding surface but not be in physical contact with the first molding surface or the second molding surface.

In some embodiments, the method can comprise wetting at least one of the first molding surface and the second molding surface with a wetting agent prior to mating the second mold component to the first mold component to prevent flash from developing along a periphery of the molded lens component at a parting line created by the first mold component and the second mold component. In some embodiments, the wetting agent can be water.

The method can also comprise introducing a lens component material into the component mold cavity and curing the lens component material within the assembled mold to form a molded lens component. The method can further comprise immersing the assembled mold including the molded lens component in a solvent to dissolve the soluble core component, the first mold component, and the second mold component. Moreover, the method can also comprise heating the solvent and agitating the solvent by sonication to expedite the dissolution of the soluble core component, the first mold component, and the second mold component.

In one embodiment, the soluble core component, the first mold component, and the second mold component can all be made in part of polyvinyl alcohol. In other embodiments, at least one of the soluble core component, the first mold component, and the second mold component can be made in part of a different soluble material than polyvinyl alcohol. In some embodiments, the solvent can be water.

In some embodiments, the lens component can be a haptic of a lens (e.g., IOL or AIOL). In these embodiments, a haptic chamber can be formed within the haptic when the soluble core component is dissolved by the solvent.

In other embodiments, the lens component can be an optic portion of a lens. In these embodiments, an optic chamber can be formed within the optic portion when the soluble core component is dissolved by the solvent. Moreover, the lens component can also be part of an optic portion of a lens. At least part of an optic chamber can be formed when the soluble core component is dissolved by the solvent.

Another system for manufacturing a lens component is also disclosed. The system can comprise a first mold component made of a soluble material and a second mold component also made of a soluble material. The first mold component can comprise a first molding surface defined by a first partial component cavity. The second mold component can comprise a second molding surface defined by a second partial component cavity.

The system can also comprise a soluble core component configured to be placed on either the first molding surface or the second molding surface. The soluble core component can include at least one positioning piece. The at least one positioning piece can be configured to be placed on the first molding surface or the second molding surface. The at least one positioning piece can be at one end of the soluble core component. Another portion or segment of the soluble core component can be positioned over the first molding surface or the second molding surface but not be in physical contact with the first molding surface or the second molding surface. In other embodiments, a remainder of the soluble core component coupled to the positioning piece can be positioned over the first molding surface or the second molding surface but not be in physical contact with the first molding surface.

The first mold component can be configured to be mated to the second mold component to form an assembled mold. A segment of the soluble core component can be configured to be disposed within a component mold cavity formed by the first partial component cavity and the second partial component cavity when the first mold component is mated to the second mold component. The component mold cavity can also receive a lens component material for curing into a molded lens component.

The entire assembled mold can be immersed in a solvent after being cured. At least a segment of the soluble core component can be within the molded lens component when the assembled mold comprising the molded lens component is immersed in the solvent. The soluble core component, the first mold component, and the second mold component can be dissolved by the solvent when immersed in the solvent.

In some embodiments, the system can also comprise a heated water bath configured to heat the solvent when the soluble core component, the first mold component, and the second mold component are immersed in the solvent. The system can also comprise a sonication device configured to agitate the solvent to expedite the dissolution of the soluble core component, the first mold component, and the second mold component.

In one embodiment, the soluble core component, the first mold component, and the second mold component can all be made in part of polyvinyl alcohol. In other embodiments, at least one of the soluble core component, the first mold component, and the second mold component can be made in part of a different soluble material than polyvinyl alcohol. In some embodiments, the solvent can be water.

In some embodiments, the lens component can be a haptic of a lens (e.g., IOL or AIOL). In these embodiments, a haptic chamber can be formed within the haptic when the soluble core component is dissolved by the solvent.

In other embodiments, the lens component can be an optic portion of a lens. In these embodiments, an optic chamber can be formed within the optic portion when the soluble core component is dissolved by the solvent. Moreover, the lens component can also be part of an optic portion of a lens. At least part of an optic chamber can be formed when the soluble core component is dissolved by the solvent.

Another method of manufacturing a lens component is also disclosed. The method comprises providing a first mold component made of a soluble material and a second mold component made of a non-soluble material or providing the first mold component made of a non-soluble material and a second mold component made of the soluble material. The first mold component can comprise a first molding surface defined by a first partial component cavity. The second mold component can comprise a second molding surface defined by a second partial component cavity.

The method can also comprise placing at least part of a soluble core component made of a soluble material on either the first molding surface or the second molding surface and mating the second mold component to the first mold component to form an assembled mold. A segment of the soluble core component can be disposed within a component mold cavity formed by the first partial component cavity and the second partial component cavity when the first mold component is mated to the second mold component.

In some embodiments, placing at least part of the soluble core component on the first molding surface or the second molding surface can comprise placing at least one positioning piece of the soluble core component on the first molding surface or the second molding surface. The at least one positioning piece can be at one end of the soluble core component. Another portion or segment of the soluble core component can be positioned over the first molding surface or the second molding surface but not be in physical contact with the first molding surface or the second molding surface. In other embodiments, a remainder of the soluble core component coupled to the positioning piece can be positioned over the first molding surface or the second molding surface but not be in physical contact with the first molding surface or the second molding surface.

The method can also comprise introducing a lens component material into the component mold cavity and curing the lens component material within the assembled mold to form a molded lens component. The method can further comprise separating the second mold component from the first mold component after the curing step.

The method can also comprise immersing either the first mold component made of the soluble material and the molded lens component in a solvent or immersing the second mold component made of the soluble material and the molded lens component in the solvent to dissolve the soluble core component and the mold component made of the soluble material. Moreover, the method can also comprise heating the solvent and agitating the solvent by sonication to expedite the dissolution of the soluble core component and the mold component made of the soluble material.

In some embodiments, the method can comprise wetting at least one of the first molding surface and the second molding surface with a wetting agent prior to mating the second mold component to the first mold component to prevent flash from developing along a periphery of the molded lens component at a parting line created by the first mold component and the second mold component. In some embodiments, the wetting agent can be water.

In one embodiment, the soluble core component and either the first mold component or the second mold component can be made in part of polyvinyl alcohol. In other embodiments, the soluble core component can be made in part of a different soluble material than polyvinyl alcohol. In these and other embodiments, either the first mold component or the second mold component can be made in part of a different soluble material than polyvinyl alcohol. In some embodiments, the solvent can be water.

In some embodiments, the lens component can be a haptic of a lens (e.g., IOL or AIOL). In these embodiments, a haptic chamber can be formed within the haptic when the soluble core component is dissolved by the solvent.

In other embodiments, the lens component can be an optic portion of a lens. In these embodiments, an optic chamber can be formed within the optic portion when the soluble core component is dissolved by the solvent. Moreover, the lens component can also be part of an optic portion of a lens. At least part of an optic chamber can be formed when the soluble core component is dissolved by the solvent.

The method can also comprise placing a soluble plug within a plug cavity defined along either the first molding surface or the second molding surface prior to forming the assembled mold. The soluble plug can be configured to occupy the plug cavity when the second mold component is mated to the first mold component. The assembled mold comprising the lens component material, the soluble core component, and the soluble plug can be cured together.

After the curing step, the second mold component can be separated from the first mold component. The molded lens component, the soluble plug, and the mold component made of the soluble material can be immersed in the solvent. The molded lens component, the soluble plug, and the molded lens component made of the soluble material can dissolve when immersed in the solvent. The soluble plug can be configured to prevent flash around a periphery of the molded lens component.

Another system for manufacturing a lens component is also disclosed. The system can comprise either a first mold component made of a soluble material and a second mold component made of a non-soluble material or a first mold component made of a non-soluble material and a second mold component made of a soluble material. The first mold component can comprise a first molding surface defined by a first partial component cavity. The second mold component can comprise a second molding surface defined by a second partial component cavity.

The system can also comprise a soluble core component configured to be placed on either the first molding surface or the second molding surface. The soluble core component can include at least one positioning piece. The at least one positioning piece can be configured to be placed on either the first molding surface or the second molding surface. The at least one positioning piece can be at one end of the soluble core component. Another portion or segment of the soluble core component can be positioned over the first molding surface or the second molding surface but not be in physical contact with the first molding surface or the second molding surface. In other embodiments, the soluble core component can comprise at least one positioning piece on one end of the soluble core component and a free distal end on an opposite end of the soluble core component. The free distal end of the soluble core component can be configured to be positioned over the first molding surface or the second molding surface but not be in physical contact with the first molding surface or the second molding surface when the at least one positioning piece is positioned on the first molding surface.

The first mold component can be configured to be mated to the second mold component to form an assembled mold. A segment of the soluble core component can be configured to be disposed within a component mold cavity formed by the first partial component cavity and the second partial component cavity when the first mold component is mated to the second mold component. The component mold cavity can also receive a lens component material for curing into a molded lens component.

The second mold component can be separated from the first mold component and the molded lens component after being cured. The molded lens component and the mold component made of the soluble material can be immersed in the solvent after being cured. At least a segment of the soluble core component can be within the molded lens component when the molded lens component and the mold component made of the soluble material are immersed in the solvent. The soluble core component and the mold component made of the soluble material can be dissolved by the solvent when immersed in the solvent.

In some embodiments, the system can also comprise a heated water bath configured to heat the solvent when the soluble core component and the mold component made of the soluble material are immersed in the solvent. The system can also comprise a sonication device configured to agitate the solvent to expedite the dissolution of the soluble core component and the mold component made of the soluble material.

In one embodiment, the soluble core component and either the first mold component or the second mold component can be made in part of polyvinyl alcohol. In other embodiments, the soluble core component can be made in part of a different soluble material than polyvinyl alcohol or either the first mold component or the second mold component can be made in part of a different soluble material than polyvinyl alcohol. In some embodiments, the solvent can be water.

In some embodiments, the lens component can be a haptic of a lens (e.g., IOL or AIOL). In these embodiments, a haptic chamber can be formed within the haptic when the soluble core component is dissolved by the solvent.

In other embodiments, the lens component can be an optic portion of a lens. In these embodiments, an optic chamber can be formed within the optic portion when the soluble core component is dissolved by the solvent. Moreover, the lens component can also be part of an optic portion of a lens. At least part of an optic chamber can be formed when the soluble core component is dissolved by the solvent.

The system can further comprise a soluble plug configured to be placed within a plug cavity defined along either the first molding surface or the second molding surface prior to forming the assembled mold. The soluble plug can be configured to occupy the plug cavity when the second mold component is mated to the first mold component. The assembled mold comprising the lens component material, the soluble core component, and the soluble plug can be cured together.

After the curing step, the second mold component can be separated from the first mold component. The molded lens component, the soluble plug, and the mold component made of the soluble material can be immersed in the solvent. The soluble core component, the soluble plug, and the mold component made of the soluble material can be configured to be dissolved when immersed in the solvent. The soluble plug can be configured to prevent flash around a periphery of the molded lens component.

### BRIEF DESCRIPTION OF THE DRAWINGS

FIG. 1A illustrates a top plan view of an embodiment of an accommodating intraocular lens comprising components that can be made using soluble cores and molds.

FIGS. 1B and 1C illustrate sectional views of the accommodating intraocular lens.

FIG. 1D illustrates an exploded view of an embodiment of an accommodating intraocular lens comprising components that can be made using soluble cores and molds.

FIG. 2A illustrates an embodiment of a first mold component comprising a first molding surface defined by a first partial component cavity.

FIG. 2B illustrates an embodiment of a second mold component comprising a second molding surface defined by a second partial component cavity.

FIG. 2C illustrates an embodiment of a clamping member for securing the first mold component to the second mold component.

FIG. 2D illustrates an embodiment of a soluble core component placed on the first molding surface of the first mold component

FIG. 2E illustrates an assembled mold comprising the first mold component mated to the second mold component.

FIG. 3A illustrates a perspective view of an embodiment of a soluble core component.

FIG. 3B illustrates a perspective view of another embodiment of a soluble core component.

FIGS. 4A-4D illustrate cross-sectional views of embodiments of soluble core components.

FIG. 5A illustrates a cross-sectional view of an embodiment of a haptic made using the soluble core component of FIG. 4A.

FIG. 5B illustrates a cross-sectional view of an embodiment of a haptic made using the soluble core component of FIG. 4B.

FIG. 6 illustrates a top plan view of an embodiment of a haptic comprising an interior cavity pattern made using the soluble cores and molds disclosed herein.

FIG. 7 illustrates an embodiment of a system for manufacturing a lens component.

FIG. 8 illustrates a cross-sectional view of an embodiment of an assembled mold comprising soluble plugs to prevent flash.

FIG. 9A illustrates an embodiment of an optic portion of an accommodating intraocular lens.

FIG. 9B illustrates a cross-sectional exploded view of embodiments of mold components and soluble core components for making the optic portion shown in FIG. 9A.

### DETAILED DESCRIPTION

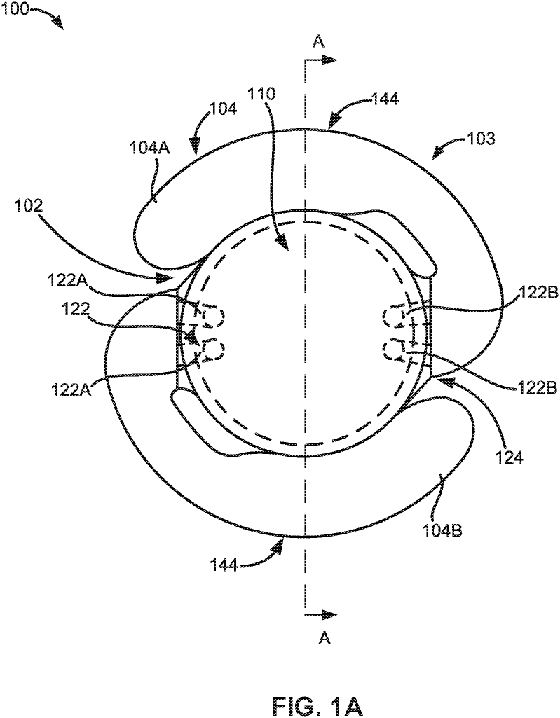

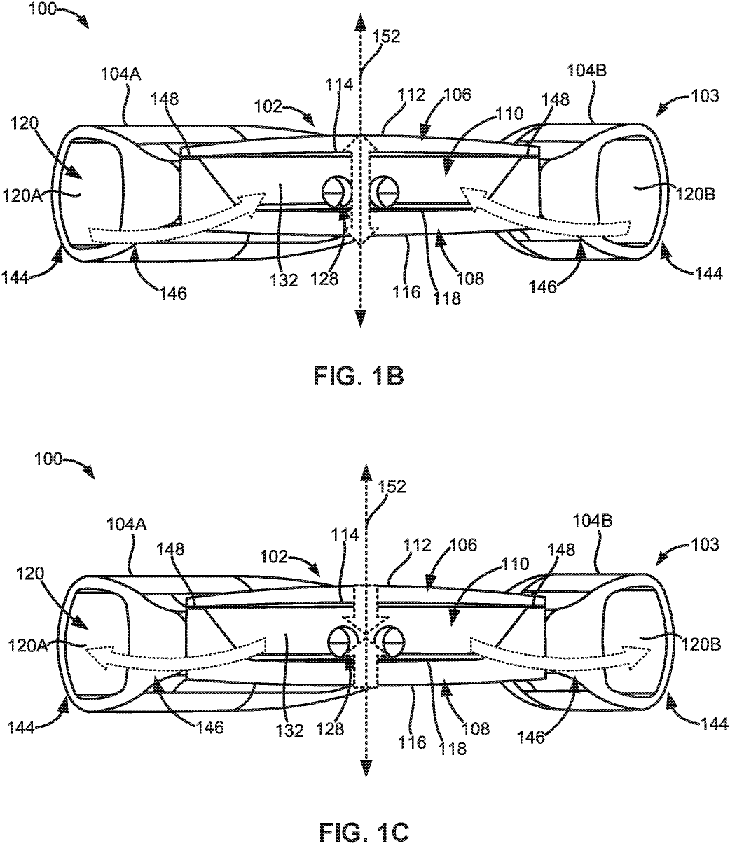

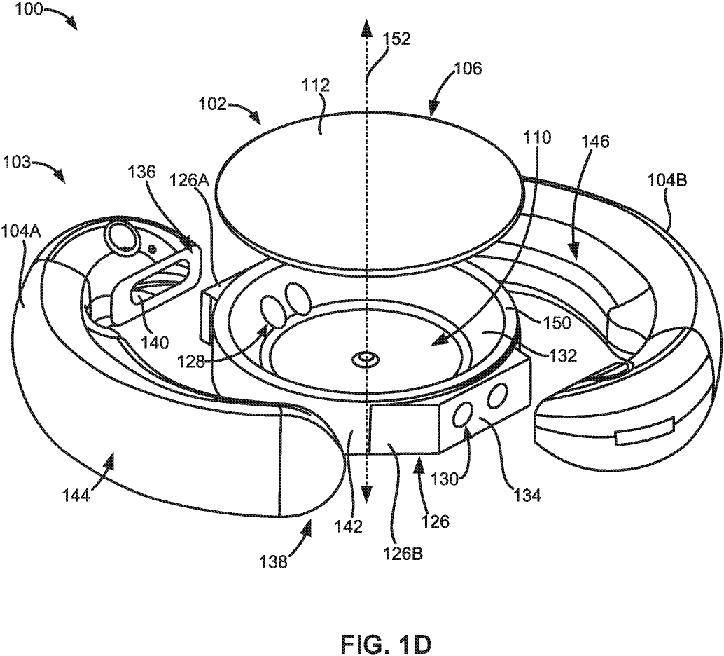

Disclosed herein are apparatus, systems, and methods of forming components of IOLs or AIOLs with soluble cores and molds. For example, FIGS. 1A-1D illustrate embodiments of AIOLs that can be made from lens components (e.g., haptics or optic portions) formed using the soluble cores and molds methods described herein.

FIG. 1A illustrates a top plan view of an embodiment of an accommodating intraocular lens (AIOL) 100 comprising lens components that can be made using soluble cores and molds. The AIOL 100 can be implanted within a subject to correct for defocus aberration, corneal astigmatism, spherical aberration, or a combination thereof. The AIOL 100 can comprise an optic portion 102 and a peripheral portion 103 that, in this embodiment, comprises one or more haptics 104 including a first haptic 104A and a second haptic 104B coupled to and extending peripherally from the optic portion 102. The AIOL 100 is configured to be positioned within a native capsular bag in which a native lens has been removed.

When implanted within the native capsular bag, the optic portion 102 can be adapted to refract light that enters the eye onto the retina. The peripheral portion 103 (e.g., the one or more haptics 104) can be configured to engage the capsular bag and is adapted to deform in response to ciliary muscle movement (e.g., muscle relaxation, muscle contraction, or a combination thereof) in connection with capsular bag reshaping. Engagement of the peripheral portion 103 (e.g., the one or more haptics 104) with the capsular bag will be discussed in more detail in the following sections.

FIGS. 1B and 1C illustrate sectional views of the AIOL 100 taken along cross-section A-A of FIG. 1A. As shown in FIGS. 1B and 1C, the optic portion 102 can comprise an anterior element 106 and a posterior element 108. A fluid-filled optic fluid chamber 110 can be defined in between the anterior element 106 and the posterior element 108.

The anterior element 106 can comprise an anterior optical surface 112 and an anterior inner surface 114 opposite the anterior optical surface 112. The posterior element 108 can comprise a posterior optical surface 116 and a posterior inner surface 118 opposite the posterior optical surface 116. Any of the anterior optical surface 112, the posterior optical surface 116, or a combination thereof can be considered and referred to as an external optical surface. The anterior inner surface 114 and the posterior inner surface 118 can face the optic fluid chamber 110. At least part of the anterior inner surface 114 and at least part of the posterior inner surface 118 can serve as chamber walls of the optic fluid chamber 110.

Each of the one or more haptics 104 can comprise a haptic fluid chamber 120 within the haptic 104. For example, the first haptic 104A can comprise a first haptic fluid chamber 120A within the first haptic 104A and the second haptic 104B can comprise a second haptic fluid chamber 120B within the second haptic 104B. The haptic fluid chamber 120 (e.g., any of the first haptic fluid chamber 120A, the second haptic fluid chamber 120B, or a combination thereof) can be in fluid communication with or fluidly connected to the optic fluid chamber 110.

The optic fluid chamber 110 can be in fluid communication with the one or more haptic fluid chambers 120 through a pair of fluid channels 122 (see FIG. 1A). The fluid channels 122 can be conduits or passageways fluidly connecting the optic fluid chamber 110 to the haptic fluid chamber 120. The pair of fluid channels 122 can be spaced apart from one another. For example, the pair of fluid channels 122 can be spaced apart between about 0.1 mm to about 1.0 mm. In some embodiments, each of the pair of fluid channels 122 has a diameter of between about 0.4 mm to about 0.6 mm.

In some embodiments, the pair of fluid channels 122 can be defined and extend through part of the optic portion 102. More specifically, the pair of fluid channels 122 can be defined and extend through the posterior element 108.

FIG. 1A illustrates that one or more haptics 104 of the peripheral portion 103 can be coupled to the optic portion 102 at a haptic-optic interface 124. For example, the one or more haptics 104 can be coupled to the optic portion at a reinforced portion 126 (see FIG. 1D) along the optic portion 102. The reinforced portion 126 can be part of the haptic-optic interface 124. The pair of fluid channels 122 can be defined or formed within part of the reinforced portion 126.

The optic fluid chamber 110 can be in fluid communication with the first haptic fluid chamber 120A through a first pair of fluid channels 122A. The optic fluid chamber 110 can also be in fluid communication with the second haptic fluid chamber 120B through a second pair of fluid channels 122B.

The two fluid channels of the first pair of fluid channels 122A can be spaced apart from one another. The two fluid channels of the first pair of fluid channels 122A can be spaced apart from one another between about 0.1 mm to about 1.0 mm. The two fluid channels of the second pair of fluid channels 122B can be spaced apart from one another. The two fluid channels of the second pair of fluid channels 122B can be spaced apart from one another between about 0.1 mm to about 1.0 mm.

In some embodiments, the first pair of fluid channels 122A and the second pair of fluid channels 122B can be positioned substantially on opposite sides of the optic portion 102. The first pair of fluid channels 122A can be positioned substantially diametrically opposed to the second pair of fluid channels 122B.

The first pair of fluid channels 122A and the second pair of fluid channels 122B can be defined or extend through part of the optic portion 102. The first pair of fluid channels 122A and the second pair of fluid channels 122B can be defined or extend through the posterior element 108.

A design with two fluid channels 122 rather than one channel helps maintain dimensional stability during assembly, which can be important when assembling flexible and thin components. Additionally, it was observed through experimentation that a design with two fluid channels 122 provided better optical quality than certain one-channel designs throughout the range of accommodation. The additional stiffness of the two fluid channel design results in less deflection due to pressure changes in the fluid channels.

As shown in FIG. 1D, the optic portion 102 can comprise a first reinforced portion 126A and a second reinforced portion 126B substantially on opposing sides of the optic portion 102 or substantially diametrically opposed to one another. The first pair of fluid channels 122A can be defined or formed within the first reinforced portion 126A. The second pair of fluid channels 122B can be defined or formed within the second reinforced portion 126B.

The pair of fluid channels 122 (e.g., any of the first pair of fluid channels 122A or the second pair of fluid channels 122B) can have a pair of inner apertures 128 disposed at one end of the fluid channels 122 and another pair of outer apertures 130 disposed at the other end of the fluid channels 122. The pair of inner apertures 128 can be defined or formed on part of the posterior element 108. As shown in FIGS. 1B-1D, the inner apertures 128 can be defined or formed on part of a raised inner surface 132 of the posterior element 108. In some embodiments, the raised inner surface 132 can be a sloped or beveled surface.

The pair of outer apertures 130 can be defined or formed on part of a protruding outer surface 134 of the posterior element 108. The protruding outer surface 134 can be part of the reinforced portion 126. The protruding outer surface 134 can also be part of the haptic-optic interface 124.

For example, FIG. 1D shows a pair of inner apertures 128 disposed at one end of the first pair of fluid channels 122A and defined along the raised inner surface 132 of the posterior element 108. FIG. 1D also shows a pair of outer apertures 130 serving as ends of the second pair of fluid channels 122B and defined along the protruding outer surface 134 of the posterior element 108. The pair of outer apertures 130 of the first pair of fluid channels 122A and the pair of inner apertures 128 of the second pair of fluid channels 122B are obscured in FIG. 1D.

The two apertures of the pair of inner apertures 128 can be spaced apart from one another between about 0.1 mm to about 1.0 mm. The two apertures of the pair of outer apertures 130 can be spaced apart from one another between about 0.1 mm to about 1.0 mm. The pair of inner apertures 128 of the first pair of fluid channels 122A can be positioned diametrically opposed to or on opposite sides of the raised inner surface 132 from the pair of inner apertures 128 of the second pair of fluid channels 122B.

FIG. 1D also illustrates that each of the haptics 104 (e.g., any of the first haptic 104A or the second haptic 104B) can have an optic attachment end 136 and a closed free end 138. A haptic fluid port 140 can be defined at the optic attachment end 136 of the haptic 104. The haptic fluid port 140 can serve as a chamber opening of the haptic fluid chamber 120. Fluid within the haptic fluid chamber 120 can flow out of the haptic fluid chamber 120 through the haptic fluid port 140 and into the optic fluid chamber 110 via the pair of fluid channels 122 when the haptic 104 is coupled to the optic portion 102. Similarly, fluid within the optic fluid chamber 110 can flow out of the optic fluid chamber 110 through the pair of fluid channels 122 and into the haptic fluid chamber 120 through the haptic fluid port 140.

As shown in FIGS. 1A and 1D, a haptic 104 can couple to the optic portion 102 at a reinforced portion 126. For example, the first haptic 104A can couple or be attached to the optic portion 102 at the first reinforced portion 126A and the second haptic 104B can couple or be attached to the optic portion 102 at the second reinforced portion 126B.

More specifically, the haptic attachment end 136 can couple to the protruding outer surface 134 of the posterior element 108. The protruding outer surface 134 can also be referred to as a “landing” or “haptic attachment landing.” The protruding outer surface 134 can extend out radially from an outer peripheral surface 142 of the optic portion 102. For example, the protruding outer surface 134 can extend out radially from an outer peripheral surface 142 of the posterior element 108 of the optic portion 102. The protruding outer surface 134 can extend out radially from the outer peripheral surface 142 between about 10 microns and 1.0 mm or between about 10 microns and 500 microns.

The haptic attachment end 136 can have a substantially flat surface to adhere or otherwise couple to a substantially flat surface of the protruding outer surface 134. When the haptic attachment end 136 is coupled to the protruding outer surface 134, the haptic fluid port 140 can surround the outer apertures 130 of the fluid channels 122. The haptics 104 can be coupled or adhered to the optic portion 102 via biocompatible adhesives 148. In some embodiments, the adhesives 148 can be the same adhesives used to couple or adhere the anterior element 106 to the posterior element 108. The adhesives 148 will be discussed in more detail in the following sections.

Each of the haptics 104 can also comprise a radially outer portion 144 configured to face and contact an inner surface of a patient’s capsular bag when the AIOL 100 is implanted within the capsular bag. Each of the haptics 104 can also comprise a radially inner portion 146 configured to face the outer peripheral surface 142 of the optic portion 102. Engagement of the capsular bag with the radially outer portion 144 of the haptics 104 will be discussed in more detail in the following sections.

The optic portion 102 can have a base power or base spherical power. The base power of the optic portion 102 can be configured to change based on an internal fluid pressure within the fluid-filled optic fluid chamber 110. The base power of the optic portion 102 can be configured to increase or decrease as fluid enters or exits the fluid-filled optic fluid chamber 110.

The base power of the optic portion 102 can be configured to increase as fluid enters the fluid-filled optic fluid chamber 110 from the haptic fluid chamber(s) 120, as shown in FIG. 1B. The base power of the optic portion 102 can be configured to decrease as fluid exits or is drawn out of the fluid-filled optic fluid chamber 110 into the haptic fluid chamber(s) 120, as shown in FIG. 1C.

It should be noted that although FIG. 1B illustrates the fluid entering the optic fluid chamber 110 from the haptic fluid chambers 120 using the curved broken-line arrows, fluid enters the optic fluid chamber 110 via the fluid channels 122 (including through the inner apertures 128 and outer apertures 130) and haptic fluid ports 140. It should also be noted that although FIG. 1C illustrates the fluid exiting the optic fluid chamber 110 into the haptic fluid chambers 120 using the curved broken-line arrows, fluid exits the optic fluid chamber 110 via the fluid channels 122 (including through the inner apertures 128 and outer apertures 130) and haptic fluid ports 140.

The optic portion 102 can be made in part of a deformable or flexible material. In some embodiments, the optic portion 102 can be made in part of a deformable or flexible polymeric material. For example, the anterior element 106, the posterior element 108, or a combination thereof can be made in part of a deformable or flexible polymeric material. The one or more haptics 104 (e.g., the first haptic 104A, the second haptic 104B, or a combination thereof) can be made in part of the same deformable or flexible material as the optic portion 102. In other embodiments, the one or more haptics 104 can be made in part of different materials from the optic portion 102.

In some embodiments, the optic portion 102 can comprise or be made in part of a lens body material. The lens body material can be made in part of a cross-linked copolymer comprising a copolymer blend. The copolymer blend can comprise an alkyl acrylate or methacrylate, a fluoro-alkyl (meth)acrylate, and a phenyl-alkyl acrylate. It is contemplated by this disclosure and it should be understood by one of ordinary skill in the art that these types of acrylic cross-linked copolymers can be generally copolymers of a plurality of acrylates, methacrylates, or a combination thereof and the term “acrylate” as used herein can be understood to mean acrylates, methacrylates, or a combination thereof interchangeably unless otherwise specified. The cross-linked copolymer used to make the lens body material can comprise an alkyl acrylate in the amount of about 3% to 20% (wt%), a fluoro-alkyl acrylate in the amount of about 10% to 35% (wt%), and a phenyl-alkyl acrylate in the amount of about 50% to 80% (wt%). In some embodiments, the cross-linked copolymer can comprise or be made in part of an n-butyl acrylate as the alkyl acrylate, trifluoroethyl methacrylate as the fluoro-alkyl acrylate, and phenylethyl acrylate as the phenyl-alkyl acrylate. More specifically, the cross-linked copolymer used to make the lens body material can comprise n-butyl acrylate in the amount of about 3% to 20% (wt%) (e.g., between about 12% to 16%), trifluoroethyl methacrylate in the amount of about 10% to 35% (wt%) (e.g., between about 17% to 21%), and phenylethyl acrylate in the amount of about 50% to 80% (wt%) (e.g., between about 64% to 67%).

The final composition of the cross-linked copolymer used to make the lens body material can also comprise a cross-linker or cross-linking agent such as ethylene glycol dimethacrylate (EGDMA). For example, the final composition of the cross-linked copolymer used to make the lens body material can also comprise a cross-linker or cross-linking agent (e.g., EGDMA) in the amount of about 1.0%. The final composition of the cross-linked copolymer used to make the lens body material can also comprise an initiator or initiating agent (e.g., Perkadox 16) and a UV absorber.

The haptic(s) 104 can comprise or be made in part of a haptic material. The haptic material can comprise or be made in part of a cross-linked copolymer comprising a copolymer blend. The copolymer blend can comprise an alkyl acrylate, a fluoro-alkyl acrylate, and a phenyl-alkyl acrylate. For example, the cross-linked copolymer used to make the haptic material can comprise an alkyl acrylate in the amount of about 10% to 25% (wt%), a fluoro-alkyl acrylate in the amount of about 10% to 35% (wt%), and a phenyl-alkyl acrylate in the amount of about 50% to 80% (wt%). In some embodiments, the cross-linked copolymer used to make the haptic material can comprise n-butyl acrylate in the amount of about 10% to 25% (wt%) (e.g., between about 19% to about 23%), trifluoroethyl methacrylate in the amount of about 10% to 35% (wt%) (e.g., between about 14% to about 18%), and phenylethyl acrylate in the amount of about 50% to 80% (wt%) (e.g., between about 58% to about 62%). The final composition of the cross-linked copolymer used to make the haptic material can also comprise a cross-linker or cross-linking agent, such as EGDMA, in the amount of about 1.0%. The final composition of the cross-linked copolymer used to make the haptic material can also comprise a number of photoinitiators or photoinitiating agents (e.g., camphorquinone, 1-phenyl-1,2-propanedione, and 2-ethylhexyl-4-(dimenthylamino)benzoate).

In some embodiments, the refractive index of the lens body material can be between about 1.48 and about 1.53. In certain embodiments, the refractive index of the lens body material can be between about 1.50 and about 1.53 (e.g., about 1.5178).

The optic portion 102 can be configured to deform, flex, or otherwise change shape (see FIGS. 1B and 1C) in response to fluid entering or exiting the optic fluid chamber 110. The optic portion 102 can be configured to deform, flex, or otherwise change shape as a result of the material composition (e.g., the polymeric composition) of the optic portion 102 discussed heretofore. The haptic(s) 104 can also be configured to deform or otherwise change shape in response to interactions or engagement with the capsular bag of a patient when the AIOL 100 is implanted within an eye of the patient. The haptic(s) 104 can be configured to deform or otherwise change shape as a result of the material composition of the haptics 104.

In some embodiments, the anterior element 106 can be configured to deform, flex, or otherwise change shape (e.g., change its curvature) in response to fluid entering or exiting the optic fluid chamber 110. In other embodiments, the posterior element 108 can be configured to deform, flex, or otherwise change shape (e.g., change its curvature) in response to fluid entering or exiting the optic fluid chamber 110. In further embodiments, both the anterior element 106 and the posterior element 108 can be configured to deform, flex, or otherwise change their shapes in response to fluid entering or exiting the optic fluid chamber 110.

In some embodiments, the fluid within the optic fluid chamber 110, the haptic fluid chamber(s) 120, or a combination thereof can be an oil. More specifically, in certain embodiments, the fluid within the optic fluid chamber 110, the haptic fluid chamber(s) 120, or a combination thereof can be a silicone oil or fluid. The fluid can flow between the optic fluid chamber 110 and the haptic fluid chamber(s) 120 in response to a deformation, flexing, or shape change undertaken by the haptic(s) 104, component(s) of the optic portion 102 (e.g., the anterior element 106, the posterior element 108, or a combination thereof), or a combination thereof.

The fluid within the optic fluid chamber 110, the haptic fluid chamber(s) 120, or a combination thereof can be a silicone oil or fluid comprising or made in part of a diphenyl siloxane. In other embodiments, the silicone oil or fluid can comprise or be made in part of a ratio of two dimethyl siloxane units to one diphenyl siloxane unit. More specifically, in some embodiments, the silicone oil or fluid can be a diphenyltetramethyl cyclotrisiloxane. In additional embodiments, the silicone oil or fluid can comprise or be made in part of a diphenyl siloxane and dimethyl siloxane copolymer.

The fluid (e.g., the silicone oil) can be index matched with the lens body material used to make the optic portion 102. When the fluid is index matched with the lens body material, the entire optic portion 102 containing the fluid acts as a single lens. For example, the fluid can be selected so that it has a refractive index of between about 1.48 and 1.53 (or between about 1.50 and 1.53). In some embodiments, the fluid (e.g., the silicone oil) can have a polydispersity index of between about 1.2 and 1.3. In other embodiments, the fluid (e.g., the silicone oil) can have a polydispersity index of between about 1.3 and 1.5. In other embodiments, the fluid (e.g., the silicone oil) can have a polydispersity index of between about 1.1 and 1.2. Other example fluids are described in U.S. Pat. Publication No. 2018/0153682, which is herein incorporated by reference in its entirety.

The base power of the optic portion 102 can be configured to change in response to the shape change undertaken by the shape-changing components of the optic portion 102 (e.g., the anterior element 106, the posterior element 108, or a combination thereof). The optic portion 102 can be configured to change shape in response to a physiologic muscle movement (e.g., ciliary muscle movement) undertaken by a patient when the AIOL 100 is implanted within a capsular bag of the eye of the patient and the AIOL 100 deforms or changes shape in response to ciliary muscle related capsular bag reshaping.

The AIOL 100 can be implanted or introduced into a patient’s capsular bag after a native lens has been removed from the capsular bag. The patient’s capsular bag is connected to zonule fibers which are connected to the patient’s ciliary muscles. The capsular bag is elastic and ciliary muscle movements can reshape the capsular bag via the zonule fibers. For example, when the ciliary muscles relax, the zonules are stretched. This stretching pulls the capsular bag in the generally radially outward direction due to radially outward forces. This pulling of the capsular bag causes the capsular bag to elongate, creating room within the capsular bag. When the patient’s native lens is present in the capsular bag, the native lens normally becomes flattened (in the anterior-to-posterior direction), which reduces the power of the lens, allowing for distance vision. In this configuration, the patient’s native lens is said to be in a disaccommodated state or undergoing disaccommodation.

When the ciliary muscles contract, however, as occurs when the eye is attempting to focus on near objects, the radially inner portion of the muscles move radially inward, causing the zonules to slacken. The slack in the zonules allows the elastic capsular bag to contract and exert radially inward forces on a lens within the capsular bag. When the patient’s native lens is present in the capsular bag, the native lens normally becomes more curved (e.g., the anterior part of the lens becomes more curved), which gives the lens more power, allowing the eye to focus on near objects. In this configuration, the patient’s native lens is said to be in an accommodated state or undergoing accommodation.

Therefore, any AIOLs implanted within the capsular bag should also possess mechanisms which allow for the base power of the AIOL to increase when the ciliary muscles contract and allow for the base power of the AIOL to decrease when the ciliary muscles relax.

In the present case, when the AIOL 100 is implanted or otherwise introduced into a patient’s native capsular bag, the radially outer portions 144 of the haptics 104 of the AIOL 100 can directly engage with or be in physical contact with the portion of the capsular bag that is connected to the zonules or zonule fibers. Therefore, the radially outer portions 144 of the haptics 104 can be configured to respond to capsular bag reshaping forces that are applied radially when the zonules relax and stretch as a result of ciliary muscle movements.

When the ciliary muscles contract, the peripheral region of the elastic capsular bag reshapes and applies radially inward forces on the radially outer portions 144 of the haptics 104 (for example, the elastic capsular bag applies radially inward forces on the radially outer portion 144 of the first haptic 104A and on the radially outer portion 144 of the second haptic 104B). The radially outer portions 144 of the haptics 104 then deform or otherwise changes shape and this deformation or shape change causes the volume of the haptic fluid chambers 120 to decrease. When the volume of the haptic fluid chambers 120 decreases, the fluid within the haptic fluid chambers 120 is moved or pushed into the optic fluid chamber 110 within the optic portion 102. As discussed previously, fluid moves from the haptic fluid chamber 120 into the optic fluid chamber 110 through fluid channels 122 (e.g., a pair of fluid channels 122) formed within the optic portion 102.

The optic portion 102 (any of the anterior element 106, the posterior element 108, or a combination thereof) can change shape (increase its curvature) in response to the fluid entering the optic fluid chamber 110 from the haptic fluid chambers 120. This increases the base power or base spherical power of the AIOL 100 and allows a patient with the AIOL 100 implanted within the eye of the patient to focus on near objects. The AIOL 100 can also be considered to be in an accommodated state or have undergone accommodation.

When the ciliary muscles relax, the peripheral region of the elastic capsular bag is stretched radially outward and the capsular bag elongates and more room is created within the capsular bag. The radially outer portions 144 of the haptics 104 can be configured to respond to this capsular bag reshaping by returning to its non-deformed or non-stressed configuration. This causes the volume of the haptic fluid chambers 120 to increase or return to its non-deformed volume. This increase in the volume of the haptic fluid chambers 120 causes the fluid within the optic fluid chamber 110 to be drawn out or otherwise flow out of the optic fluid chamber 110 and back into the haptic fluid chambers 120. As discussed previously, fluid moves out of the optic fluid chamber 110 into the haptic fluid chamber 120 through the same fluid channels 122 (e.g., a pair of fluid channels 122) formed within the optic portion 102.

As previously discussed, the optic portion 102 (any of the anterior element 106, the posterior element 108, or a combination thereof) can change shape (decrease its curvature or become flatter) in response to the fluid exiting the optic fluid chamber 110 and into the haptic fluid chambers 120. This decreases the base power or base spherical power of the AIOL 100 and allows a patient with the AIOL 100 implanted within the eye of the patient to focus on distant objects or provide for distance vision. The AIOL 100 can also be considered to be in a disaccommodated state or have undergone disaccommodation.

As shown in FIGS. 1B and 1C, the radially inner portion 146 of the haptics 104 can be designed to be thicker or bulkier (relative to the radially outer portion 144) to provide the haptics 104 with stiffness or resiliency in the anterior-to-posterior direction. This way, when capsular bag forces are applied to the haptics 104 in the anterior-to-posterior direction, less deformation occurs and less fluid movement occurs between the haptic fluid chambers 120 and the optic fluid chamber 110 than when forces are applied in the radial direction. Since less fluid movement occurs, less changes in the base power of the AIOL 100 occur when forces are applied to the AIOL 100 in the anterior-to-posterior direction. Thus, the design and material properties of the haptics 104 and the optic portion 102 can allow the AIOL 100 to maintain a high degree of sensitivity to radial forces applied to the haptics 104 by capsular bag reshaping caused by ciliary muscle movements.

The anterior element 106 can be attached or otherwise adhered to the posterior element 108 via adhesives 148 or an adhesive layer. In addition, the haptics 104 can also be attached to the optic portion 102 via adhesives 148.

The adhesive layer can be substantially annular-shaped. The adhesives 148 or adhesive layer can be positioned at a peripheral edge 150 (see FIG. 1D) of the optic portion 102 in between the anterior element 106 and the posterior element 108. For example, the adhesives 148 can be positioned on top of the raised inner surface 132 of the posterior element 108.

The adhesives 148 or adhesive layer can comprise or be made in part of a biocompatible adhesive. The adhesives 148 or adhesive layer can comprise or be made in part of a biocompatible polymeric adhesive.

The adhesives 148 or adhesive layer can comprise or be made in part of a cross-linkable polymer precursor formulation. The cross-linkable polymer precursor formulation can comprise or be made in part of a copolymer blend, a hydroxyl-functional acrylic monomer, and a photoinitiator.

The copolymer blend can comprise an alkyl acrylate (e.g., n-butyl acrylate in the amount of about 41% to about 45% (wt%)), a fluoro-alkyl acrylate (e.g., trifluoroethyl methacrylate in the amount of about 20% to about 24% (wt%)), and a phenyl-alkyl acrylate (phenylethyl acrylate in the amount of about 28% to about 32% (wt%)). The hydroxyl-functional acrylic monomer can be 2-hydroxyethyl acrylate (HEA).The photoinitiator can be used to facilitate curing of the adhesive. For example, the photoinitiator can be Darocur 4265 (a 50/50 blend of diphenyl(2,4,6-trimethylbenzoyl)phosphine oxide and 2-hydroxy2-methylpropiophenone).

The first step in making the adhesive is preparation of a hydroxyl-functional polymer precursor by photopolymerizing the cross-linkable polymer precursor formulation, thereby yielding a cured composition. The second step is chemical conversion of the precursor polymer pendant hydroxyl moieties, or hydroxyl pendant groups, into pendant methacrylate functional groups by reacting with a methacrylic anhydride or methacryloyl chloride, thus forming a methacrylate-functional or methacrylic-functional cross-linkable polymer comprising the alkyl acrylate or methacrylate (e.g., n-butyl acrylate), the fluoro-alkyl (meth)acrylate (e.g., trifluoroethyl methacrylate), the phenyl-alkyl acrylate (phenylethyl acrylate), and 2-(2-methyl-acryloyloxy)ethyl acrylate.

The methacrylic-functional cross-linkable polymer can be blended with a reactive acrylic monomer diluent such as 1-adamantyl methacrylate (ADMA) and the same photoinitiator (e.g., Darocur 4265). For example, the final composition of the adhesives 148 can comprise the cross-linkable polymer precursor formulation in the amount of about 50% to about 85% (wt%) (e.g., about 61% to about 65%), the reactive acrylic monomer diluent in the amount of about 10% to about 40% (wt%) (32% to about 36%), and the photoinitiator (e.g., Darocur 4265) in the amount of about 2% to about 3% (wt%).

The adhesives 148 or adhesive layer can bond, adhere, or otherwise join the anterior element 106 to the posterior element 108. As will be discussed in more detail in the following sections, the thickness of the adhesive layer can be adjusted post-implantation to adjust a base power of the AIOL 100.

In some embodiments, the same adhesives 148 used to bond the anterior element 106 to the posterior element 108 can also be used to bond or affix the peripheral portion 103 (e.g., the one or more haptics 104) to the optic portion 102.

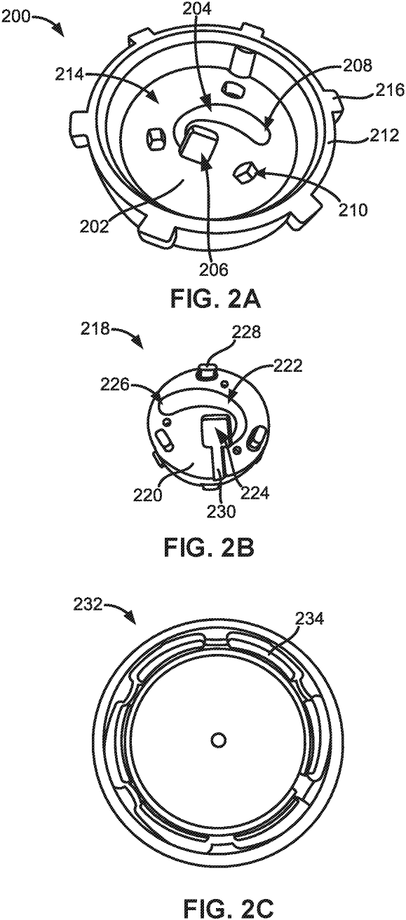

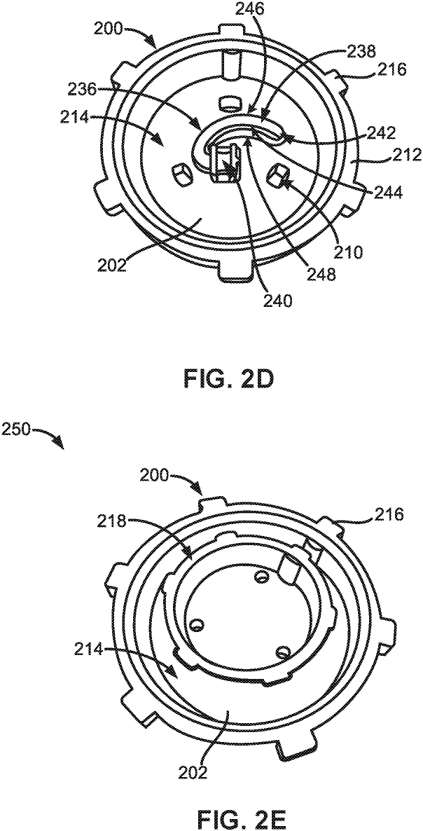

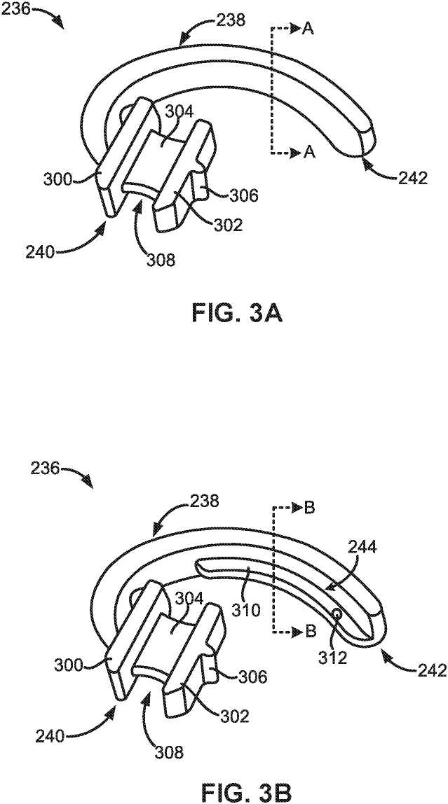

FIG. 2A illustrates an embodiment of a first mold component 200 comprising a first molding surface 202 defined by a first partial component cavity 204. The first partial component cavity 204 can be an indentation or depression defined along the first molding surface 202. The first partial component cavity 204 can be shaped, sized, or otherwise configured to accommodate part of a soluble core component 236 (see FIGS. 2D and 3A-3B). In some embodiments, the first mold component 200 can also be referred to as a wafer mold.

In some embodiments, the first partial component cavity 204 can be connected to or be contiguous with a first partial positioning cavity 206. For example, the first partial component cavity 204 can be in fluid communication with the first partial positioning cavity 206. In other embodiments, the first partial component cavity 204 can be positioned in proximity to a first partial positioning cavity 206. For example, the first partial component cavity 204 can be near the first partial positioning cavity 206 but not directly connected to the first partial positioning cavity 206.

The first partial component cavity 204 can be shaped, sized, or otherwise configured to accommodate at least part of a core body 238 (see FIGS. 2D and 3A-3B) of the soluble core component 236. For example, the first partial component cavity 204 can be shaped, sized, or otherwise configured to accommodate a posterior half of the core body 238 of the soluble core component 236.

The first partial positioning cavity 206 can be shaped, sized, or otherwise configured to accommodate at least part of a positioning piece 240 (see FIGS. 2D and 3A-3B) of the soluble core component 236. For example, the first partial positioning cavity 206 can be shaped, sized, or otherwise configured to accommodate a posterior half of the positioning piece 240 of the soluble core component 236.

Although FIGS. 2A and 2D illustrate the first mold component 200 comprising one first partial positioning cavity 206, it is contemplated by this disclosure that the first mold component 200 can comprise a plurality of first partial positioning cavities 206 for accommodating multiple positioning pieces 240.

In some embodiments, the first partial component cavity 204 can terminate at a first cavity distal end 208. The first cavity distal end 208 can be positioned at a distance from the first partial positioning cavity 206. The first cavity distal end 208 can be positioned closer to the first mold component wall 212 than the first partial positioning cavity 206. In these embodiments, the first cavity distal end 208 is not in contact with the first mold component wall 212.

In certain embodiments, the first cavity distal end 208 can be rounded or curved. For example, the first cavity distal end 208 can be substantially shaped as a partial ovoid or ellipsoid. The first cavity distal end 208 can be substantially shaped as a partial sphere.

In other embodiments not shown in FIG. 2A but contemplated by this disclosure, the first partial component cavity 204 can be connected to another partial positioning cavity instead of terminating at a closed-off distal end. In these embodiments, the first partial component cavity 204 can be disposed in between two partial positioning cavities.

As shown in FIG. 2A, the first mold component 200 can also comprise a plurality of leg cavities 210 defined along the first molding surface 202. The leg cavities 210 can be divots or indentations configured to accommodate legs or other support structures extending from a complementary mold component (for example, a second mold component 218, see FIG. 2B).

The leg cavities 210 can surround or be positioned radially outward of the first partial component cavity 204. The leg cavities 210 can be arranged in a particular pattern or positioned in a specific manner to allow a complementary mold component (for example, the second mold component 218) to be registered to the first mold component 200. For example, the leg cavities 210 can be arranged in a particular pattern or aligned in a specific manner to allow the first partial component cavity 204 to be matched or otherwise aligned with a second partial component cavity 222 on the second mold component (see, for example, FIG. 2B). The first partial component cavity 204 can be properly aligned with the second partial component cavity 222 when the legs or other support structures on the second mold component 218 are inserted or placed into the leg cavities 210 of the first mold component 200.

In the example embodiment shown in FIG. 2A, the leg cavities 210 can be arranged in a substantially triangular pattern. In other embodiments not shown in the figures but contemplated by this disclosure, the leg cavities 210 can be arranged in a circular pattern, a diamond or rhombus pattern, a square pattern, or another polygonal pattern.

The first molding surface 202 can be sunken or recessed with respect to a first mold component wall 212. The sunken or recessed first molding surface 202 can create a reservoir space 214 within the first mold component 200. The reservoir space 214 can receive a lens component material when the entire mold is assembled.

As shown in FIG. 2A, in one embodiment, the first mold component 200 can be configured as a circular cap or circular mold-half. In this embodiment, the first mold component wall 212 can be substantially shaped as the lateral sides of a cylinder. Moreover, the first molding surface 202 can also be substantially circular-shaped.

In other embodiments, the first mold component 200 can be configured as a rectangular cap or rectangular mold-half. In these embodiments, the first mold component wall 212 can be substantially shaped as the lateral sides of a cuboid. Moreover, the first molding surface 202 can also be substantially rectangular-shaped.

In further embodiments, the first mold component 200 including the first molding surface 202 and the first mold component wall 212 can be oval-shaped or ellipsoid-shaped. In additional embodiments, the first mold component 200 including the first molding surface 202 and the first mold component wall 212 can be triangular-shaped or shaped as another type of polygon.

The first mold component 200 can also comprise a plurality of engagement features 216 extending radially outward from the first mold component wall 212. In some embodiments, the engagement features 216 can be tabs or flaps extending radially outward from the first mold component wall 212. In other embodiments, the engagement features 216 can comprise threads or a thread-pattern defined on an exterior of the first mold component wall 212. The engagement features 216 can allow the first mold component 200 to more easily engage or couple with a clamping member 232 (see, for example, FIG. 2C) for securing or holding together an assembled mold.

FIG. 2B illustrates an embodiment of a second mold component 218 comprising a second molding surface 220 defined by a second partial component cavity 222. The second partial component cavity 222 can be an indentation or depression defined along the second molding surface 220. The second partial component cavity 222 can be shaped, sized, or otherwise configured to accommodate part of the soluble core component 236. In some embodiments, the second mold component 218 can also be referred to as a wafer mold.

The second molding surface 220 can be configured or otherwise designed to face the first molding surface 202 when the second mold component 218 is mated to the first mold component 200 to form an assembled mold 250 (see FIG. 2E). The second molding surface 220 can be located on an underside of the second mold component 218 (the underside is facing upwards in FIG. 2B).

In some embodiments, the second partial component cavity 222 can be connected to or be contiguous with a second partial positioning cavity 224. For example, the second partial component cavity 222 can be in fluid communication with the second partial positioning cavity 224. In other embodiments, the second partial component cavity 222 can be positioned in proximity to a second partial positioning cavity 224. For example, the second partial component cavity 222 can be near the second partial positioning cavity 224 but not directly connected to the second partial positioning cavity 224.

The second partial component cavity 222 can be shaped, sized, or otherwise configured to accommodate at least part of the core body 238 of the soluble core component 236. For example, the second partial component cavity 222 can be shaped, sized, or otherwise configured to accommodate an anterior half of the core body 238 of the soluble core component 236.

In addition, the second partial positioning cavity 224 can be shaped, sized, or otherwise configured to accommodate at least part of a positioning piece 240 of the soluble core component 236. For example, the second partial positioning cavity 224 can be shaped, sized, or otherwise configured to accommodate a posterior half of the positioning piece 240 of the soluble core component 236.

Although FIG. 2B illustrates the second mold component 218 comprising one second partial positioning cavity 224, it is contemplated by this disclosure that the second mold component 218 can comprise a plurality of second partial positioning cavities 224 for accommodating multiple positioning pieces 240.

In some embodiments, the second partial component cavity 222 can terminate at a second cavity distal end 226. The second cavity distal end 226 can be positioned at a distance from the second partial positioning cavity 224. The second cavity distal end 226 can be positioned closer to the edge or periphery of the second molding surface 220 than the second partial positioning cavity 224. In these embodiments, the second cavity distal end 226 does not reach the edge of the second molding surface 220.

In certain embodiments, the second cavity distal end 226 can be rounded or curved. For example, the second cavity distal end 226 can be substantially shaped as a partial ovoid or ellipsoid. The second cavity distal end 226 can be substantially shaped as a partial sphere.

In other embodiments not shown in FIG. 2B but contemplated by this disclosure, the second partial component cavity 222 can be connected to another partial positioning cavity instead of terminating at a closed-off distal end. In these embodiments, the second partial component cavity 222 can be disposed in between two partial positioning cavities.

The second mold component 218 can also comprise a plurality of legs 228 or support structures protruding or otherwise extending from the second molding surface 220. In some embodiments, the legs 228 can protrude or extend substantially orthogonally or perpendicularly from the second molding surface 220. The legs 228 of the second mold component 218 can fit within the leg cavities 210 of the first mold component 200 when the second mold component 218 is mated or otherwise coupled to the first mold component 200.

As shown in FIG. 2B, the legs 228 can surround or be positioned radially outward of the second partial component cavity 222. The legs 228 can be arranged in a particular pattern or aligned in a specific manner to allow the second mold component 218 to be properly registered to the first mold component 200. For example, the legs 228 can be arranged in a particular pattern or aligned in a specific manner to allow the first partial component cavity 204 to be matched or otherwise aligned with the second partial component cavity 222. The first partial component cavity 204 can be properly aligned with the second partial component cavity 222 when the legs 228 on the second mold component 218 are inserted or placed into the leg cavities 210 of the first mold component 200.

In the example embodiment shown in FIG. 2B, the legs 228 can be arranged in a substantially triangular pattern. In other embodiments not shown in the figures but contemplated by this disclosure, the legs 228 can be arranged in a circular pattern, a diamond or rhombus pattern, a square pattern, or another polygonal pattern.

As shown in FIG. 2B, in one embodiment, the second mold component 218 can be configured as a circular mold-half. In this embodiment, the second molding surface 220 can also be substantially circular-shaped.

In other embodiments, the second mold component 218 can be configured as a rectangular mold-half. In these embodiments, the second molding surface 220 can also be substantially rectangular-shaped.

In further embodiments, the second mold component 218 including the second molding surface 220 can be oval-shaped or ellipsoid-shaped. In additional embodiments, the second mold component 218 including the second molding surface 220 can be triangular-shaped or shaped as another type of polygon.

In some embodiments, the second mold component 218 can be sized to fit within the reservoir space 214 of the first mold component 200. At least part of the second mold component 218 can be within the reservoir space 214 when the first mold component 200 is mated or otherwise coupled to the second mold component 218.

The first partial component cavity 204 and the second partial component cavity 222 can come together to form a component mold cavity when the first mold component 200 is mated or otherwise coupled to the second mold component 218. For example, the first mold component 200 can be mated to the second mold component 218 when the first mold component 200 is clamped to the second mold component 218. In addition, the first partial positioning cavity 206 and the second partial positioning cavity 224 can come together to form a positioning cavity when the first mold component 200 is mated or otherwise coupled to the second mold component 218.

The component mold cavity can be in fluid communication with the reservoir space 214 of the first mold component 200. The lens component material can seep into the component mold cavity from the reservoir space 214. The low viscosity lens component material can seep into the component mold cavity through the parting lines between the first mold component 200 and the second mold component 218. The lens component material can be drawn into the component mold cavity from the reservoir space 214 when the assembled mold 250 is placed into a vacuum chamber and a vacuum is drawn.

The second mold component 218 can also comprise a vent 230 or opening connecting the second partial positioning cavity 224 to an edge or periphery of the second mold component 218. The vent 230 can allow air to escape while the component mold cavity is being filled with the low-viscosity lens component material.

In some embodiments, the lens component material can be the haptic material disclosed in the preceding sections. For example, the lens component material can comprise curable acrylic monomers. The lens component material can be a substantially hydrophobic material.

FIG. 2C illustrates an embodiment of a clamping member 232 for securing the first mold component 200 to the second mold component 218. In the example embodiment shown in FIG. 2C, the clamping member 232 can be a clamping cap configured to be detachably fastened to the top of the first mold component 200 when the second mold component 218 is mated to the first mold component 200.

As previously discussed, the first mold component 200 can comprise a plurality of engagement features 216 extending radially outward from the first mold component wall 212. In some embodiments, the engagement features 216 can be tabs or flaps extending radially outward from the first mold component wall 212. The clamping member 232 can comprise a plurality of grooves 234 or notches for interlocking with or otherwise receiving the engagement features 216.

In other embodiments, the engagement features 216 can comprise threads or a thread-pattern defined on an exterior of the first mold component wall 212. In these embodiments, the clamping member 232 can comprise a complementary thread-pattern to allow the clamping member 232 to be screwed on to the first mold component 200.

In further embodiments, the clamping member 232 can be a traditional clamp or vise-type device for tightly securing the first mold component 200 to the second mold component 218.

The clamping member 232 can tightly secure the first mold component 200 to the second mold component 218 to prevent the various mold parts from shifting or moving relative to one another. The clamping member 232 can tightly secure the first mold component 200 to the second mold component 218 during the curing step to prevent the lens component material from seeping out from mold parting lines. The clamping member 232 can be coupled to the first mold component 200 to form an enclosed chamber. Although not shown in FIG. 2C, when the clamping member 232 is implemented as a clamping cap, the clamping cap can have a septum or inlet port defined along a surface (for example, a top surface) of the clamping cap. An injection nozzle or another delivery device can be inserted through the septum or inlet port to inject or otherwise introduce the curable lens component material into the reservoir space 214 within the enclosed chamber.

In some embodiments, the clamping member 232 can be made in part of a polymeric material, a metallic material, or a combination thereof. In further embodiments, the clamping member 232 can be made in part of a ceramic material. The clamping member 232 can be unfastened or uncoupled from the first mold component 200 after the curing step. The clamping member 232 can be unfastened or uncoupled from the first mold component 200 prior to separating the first mold component 200 from the second mold component 218.

FIG. 2D illustrates that at least part of a soluble core component 236 can be placed on the first molding surface 202 of the first mold component 200. Although FIG. 2D illustrates the soluble core component 236 placed on the first molding surface 202, it is contemplated by this disclosure that the soluble core component 236 can also be initially placed on the second molding surface 220 of the second mold component 218. In the following sections, any references to placement or positioning of the soluble core component 236 on the first molding surface 202 of the first mold component 200 can also refer to placement or positioning of the soluble core component 236 on the second molding surface 220 of the second mold component 218. Moreover, although FIGS. 2A, 2B, and 2D illustrate mold components used to form a haptic of an AIOL, it is contemplated by this disclosure that similar types of mold components can also be used to form an optic portion of a lens.

In cases where the lens component formed is a haptic of an AIOL (for example, any of the haptics 104 shown in FIGS. 1A-1D), the soluble core component 236 can comprise a core body 238 connected to at least one positioning piece 240. In these embodiments, the core body 238 can terminate at a core distal end 242. The soluble core component 236 will be discussed in more detail in the following sections.

At least part of the positioning piece 240 of the soluble core component 236 can be pressed or inserted into the first partial positioning cavity 206 of the first mold component 200. The positioning piece 240 can be configured to fit tightly within the first partial positioning cavity 206 when the positioning piece 240 is pressed or inserted into the first partial positioning cavity 206. The soluble core component 236 can be detachably coupled to the first mold component 200 when the positioning piece 240 is pressed or inserted into the first partial positioning cavity 206.

In some embodiments, the positioning piece 240 of the soluble core component 236 can be the only portion of the soluble core component 236 that physically contacts the first molding surface 202. For example, the positioning piece 240 of the soluble core component 236 can be in physical contact with the sunken or recessed portions of the first molding surface 202 defining the first partial positioning cavity 206. In these embodiments, the remainder of the soluble core component 236 coupled to or extending from the positioning piece 240 (e.g., the curved core body 238 and the core distal end 242) can be positioned over the first molding surface 202 but not be in physical contact with the first molding surface 202 when the soluble core component 236 is detachably coupled to the first mold component 200. For example, the core body 238 and the core distal end 242 can be raised or elevated by the positioning piece 240 such that no part of the core body 238 and core distal end 242 physically contacts the first molding surface 202.

In these embodiments, at least part of the core body 238 and the core distal end 242 can be positioned within the first partial component cavity 204 but not touch any part of the first molding surface 202 defining or serving as the walls and bottom of the first partial component cavity 204 when the positioning piece 240 is pressed or inserted into the first partial positioning cavity 206. In addition, no part of the core body 238 of the soluble core component 236 extends past the contour or boundary of the first partial component cavity 204 when the positioning piece 240 is pressed or inserted into the first partial positioning cavity 206. Moreover, the first cavity distal end 208 can extend past or extend beyond the core distal end 242 of the soluble core component 236 when the positioning piece 240 is pressed or inserted into the first partial positioning cavity 206. Furthermore, the raised first mold component wall 212 can surround the soluble core component 236 when the positioning piece 240 is pressed or inserted into the first partial positioning cavity 206.

FIG. 2D also illustrates that the core body 238 of the soluble core component 236 can comprise a radially inner body portion 244 and a radially outer body portion 246. The radially inner body portion 244 can be the side of the core body 238 facing toward or in proximity to the positioning piece 240 when the positioning piece 240 is pressed or inserted into the first partial component cavity 204 and the core body 238 is partially positioned within the first partial component cavity 204. The radially outer body portion 246 can be the side of the core body 238 facing away from the positioning piece 240 when the positioning piece 240 is pressed or inserted into the first partial component cavity 204 and the core body 238 is partially positioned within the first partial component cavity 204. The radially inner body portion 244 can be separated from an inner edge 248 of the first partial component cavity 204 by a radially inner separation distance. The inner edge 248 of the first partial component cavity 204 can be part of the inner contour or boundary of the first partial component cavity 204. The radially outer body portion 246 can be separated from an outer edge (not shown in FIG. 2D) of the first partial component cavity 204 by a radially outer separation distance. The outer edge of the first partial component cavity 204 can be part of the outer contour or boundary of the first partial component cavity 204.

In some embodiments, the radially inner separation distance can be greater than the radially outer separation distance. This disparity in separation distances can allow more of the lens component material to occupy the space separating the radially inner body portion 244 from the inner edge 248 than the space separating the radially outer body portion 246 from the outer edge of the first partial component cavity 204. This can allow the haptic (see, for example, the haptic 104 of FIGS. 1B and 1C) to be formed with a thicker radially inner portion (see, for example, the radially inner portion 146 of haptic 104 of FIGS. 1B and 1C) relative to the radially outer portion of the haptic (see, for example, the radially outer portion 144 of haptic 104 of FIGS. 1B and 1C).

The unique positioning of the soluble core component 236 relative to the mold component(s) can allow the lens component material (e.g., the haptic material) to enter and fill the space surrounding the soluble core component 236 within the component cavities. The haptic material can then be cured to form a molded haptic surrounding the soluble core component 236. After the curing process, the molded haptic, including the soluble core component 236 within the molded haptic, can then be immersed in a solvent to dissolve the soluble core component 236. Once the soluble core component 236 is dissolved, the space within the molded haptic previously occupied by the soluble core component 236 can serve as a haptic fluid chamber (see, for example, the haptic fluid chamber 120 of haptic 104).

FIG. 2E illustrates that an assembled mold 250 can be formed by mating the second mold component 218 to the first mold component 200. The soluble core component 236 can be pressed or otherwise placed into position within the first mold component 200 prior to the second mold component 218 mating with the first mold component 200. The soluble core component 236 can be placed into position within the first mold component 200 by pressing or inserting the positioning piece 240 of the soluble core component 236 into the first partial positioning cavity 206 and positioning at least part of the core body 238 of the soluble core component 236 within the first partial component cavity 204. As previously discussed, the soluble core component 236 can also be initially pressed or otherwise placed into position within the second mold component 218 prior to the two mold components mating together. The soluble core component 236 can be disposed in between the first molding surface 202 and the second molding surface 220 when the assembled mold 250 is formed.

Mating the second mold component 218 to the first mold component 200 can comprise inserting the legs 228 of the second mold component 218 into the leg cavities 210 of the first mold component 200 and pressing the second mold component 218 against the first mold component 200. As previously discussed, the legs 228 of the second mold component 218 and the leg cavities 210 of the first mold component 200 can be arranged such that the first partial component cavity 204 of the first mold component 200 fits precisely over the second partial component cavity 222 of the second mold component 218. For example, the contours or boundaries of the first partial component cavity 204 can be aligned with the contours or boundaries of the second partial component cavity 222 when the second mold component 218 is mated to the first mold component 200. Moreover, the contours or boundaries of the first partial positioning cavity 206 can also be aligned with the contours or boundaries of the second partial positioning cavity 224 when the second mold component 218 is mated with the first mold component 200.

The first partial component cavity 204 and the second partial component cavity 222 can form a component mold cavity when the assembled mold 250 is formed by mating the second mold component 218 to the first mold component 200. The core body 238 of the soluble core component 236 can be disposed within the component mold cavity when the second mold component 218 is mated to the first mold component 200. The positioning piece 240 of the soluble core component 236 can be disposed outside of the component mold cavity when the second mold component 218 is mated to the first mold component 200.

In some embodiments, a method of forming the assembled mold 250 can comprise the additional step of wetting at least one of the first molding surface 202 and the second molding surface 220 with a wetting agent prior to mating the second mold component 218 to the first mold component 200. Wetting the first molding surface 202, the second molding surface 220, or a combination thereof can comprise spraying, sponging, swabbing, or otherwise applying the wetting agent to the surface(s) until the wetting agent evenly coats the surface(s). In certain embodiments, the wetting agent can be water or deionized water. Wetting the first molding surface 202, the second molding surface 220, or a combination thereof can allow the first mold component 200 to bond more tightly to the second mold component 218 when at least one of the mold components is made of a water-soluble material. Wetting the first molding surface 202, the second molding surface 220, or a combination thereof can prevent flash from developing along a periphery of the molded lens component at a parting line created by the first mold component 200 and the second mold component 218 by sealing at least part of the interface between the first mold component 200 and the second mold component 218.

FIG. 2E illustrates that the second mold component 218 can fit within the reservoir space 214 of the first mold component 200 when the second mold component 218 is mated with the first mold component 200. A curable lens component material (for example, the haptic material or the lens body material when an optic portion is being formed) can be introduced (e.g., injected, poured, etc.) into the reservoir space 214 once the assembled mold 250 has been formed. In some embodiments, the low-viscosity lens component material can seep into the component mold cavity through the parting lines between the first mold component 200 and the second mold component 218 when the mold components are mated together. In other embodiments, the lens component material can enter into the component mold cavity through other openings or conduits defined along the second molding surface 220, the first molding surface 202, or a combination thereof.

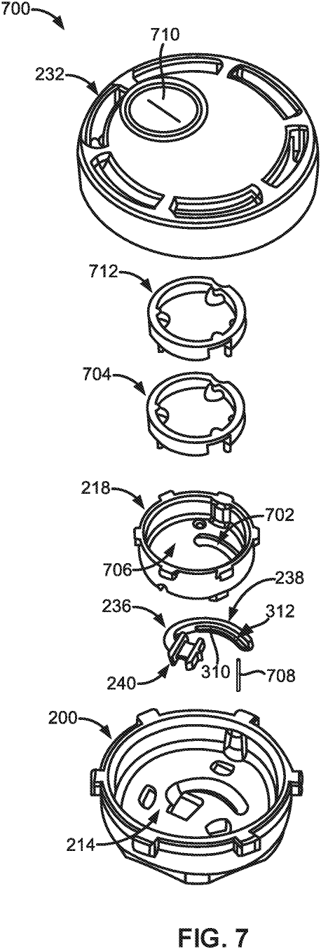

As previously discussed, a clamping member 232 (see, for example, FIG. 2C or FIG. 7) can be detachably coupled or fastened to the first mold component 200 after the first mold component 200 is mated to the second mold component 218. For example, the clamping member 232 can be a clamping cap configured to be detachably fastened to the top of the first mold component 200 when the second mold component 218 is mated to the first mold component 200. The clamping cap can create an enclosed chamber and press the second mold component 218 tightly against the first mold component 200.

A curable lens component material can then be introduced into this enclosed chamber. For example, the lens component material can be injected or otherwise introduced into the reservoir space 214 through a septum 710 (see FIG. 7) or other opening defined along the clamping member 232. Once the lens component material has been introduced, the assembled mold 250, including the clamping member 232 coupled to the assembled mold 250, can be placed within a vacuum chamber. A vacuum can be pulled after the assembled mold 250 is placed within the vacuum chamber to draw the lens component material into the component mold cavity. The low-viscosity lens component material can seep into the component mold cavity through parting lines or miniscule gaps in between the first mold component 200 and the second mold component 218. While under vacuum, the lens component material can fill the space within the assembled mold 250 unoccupied by the soluble core component 236. For example, the lens component material can fill the space within the component mold cavity unoccupied by the core body 238 of the soluble core component 236.

Once the lens component material has filled the component mold cavity, the assembled mold 250 comprising the lens component material can be cured in a curing chamber. In some embodiments, the assembled mold 250 can be cured using light such as ultraviolet (UV) light or blue light.

More specifically, in some embodiments, the assembled mold 250 can be cured in a UV light chamber. For example, the assembled mold 250 can be cured using a UV-generating xenon lamp or xenon-mercury lamp. For example, the assembled mold 250 can be cured for between 30 minutes and 60 minutes under UV light. In other embodiments, the assembled mold 250 can be cured using blue light such as light emitted by high-intensity blue light-emitting diode (LED) lights. For example, the assembled mold 250 can be cured for between 10 hours and 12 hours under blue light. In other embodiments, the assembled mold 250 can also be cured using heat or a combination of light and heat.

The clamping member 232 can clamp the first mold component 200 to the second mold component 218 during the curing procedure. The lens component material can be cured into a molded lens component such as a haptic. As will be discussed in more detail in the following sections, the lens component material can also be cured into other molded lens components such as molded optic portions using other mold components.

In some embodiments, both the first mold component 200 and the second mold component 218 can be made of a non-soluble material. The non-soluble material can be a material not capable of dissolving within a solvent (e.g., water) in a practicable amount of time. For example, the first mold component 200 and the second mold component 218 can be made of a non-soluble polymeric material. In some embodiments, the first mold component 200 and the second mold component 218 can be made from thermoplastic resins including polyolefins such as medium or high density polyethylene (PE), polypropylene (PP) or copolymers thereof, poly-4-methylpentene, and polystyrene. The first mold component 200 and the second mold component 218 can also be made from polyacetal resins, polyacrylethers, polyarylether sulfones, different types of nylon including nylon 6, nylon 66 and nylon 11. As a more specific example, the first mold component 200, the second mold component 218, or a combination thereof can be made in part of a 4-methylpentne-1-based olefin copolymer such as TPX™ polymethyl pentene distributed by Mitsui Chemicals, Inc.

In other embodiments, the first mold component 200 and the second mold component 218 can be made of a corrosion-resistant metallic material such as stainless steel.

In instances where both the first mold component 200 and the second mold component 218 are made of a non-soluble material, the method of forming the lens component (e.g., the haptic) can comprise separating the first mold component 200 from the second mold component 218 after the curing step and removing the molded lens component from either the first mold component 200 or the second mold component 218. At least a segment of the soluble core component 236 can be within the molded lens component or partially encapsulated by the molded lens component when the molded lens component is removed from the first mold component 200 or the second mold component 218. For example, the core body 238 of the soluble core component 236 can be within the molded lens component or partially encapsulated by the molded lens component when the molded lens component is removed from the first mold component 200 or the second mold component 218. Moreover, the positioning piece 240 of the soluble core component 236 can be connected to the molded lens component but not contained or encapsulated within the molded lens component.

The method can further comprise immersing the molded lens component in a solvent to dissolve the soluble core component 236. The method can also comprise heating the solvent to between about 35° C. and 55° C. and agitating the solvent by sonication or stirring to expedite the dissolution of the soluble core component 236. In some embodiments, the soluble core component 236 can be dissolved after being immersed in the solvent between about 6 hours to about 24 hours. What remains after the soluble core component has dissolved is the molded lens component (for example, a haptic or optic portion having a cavity defined therein).

As will be discussed in more detail in the following sections, the soluble core component 236 can be made of a soluble material such as polyvinyl alcohol. In some embodiments, the solvent can be water. The soluble core component 236 and the soluble material will be discussed in more detail in the following sections.

In some embodiments, both the first mold component 200 and the second mold component 218 can be made of a soluble material. In certain embodiments, the first mold component 200 and the second mold component 218 can be made of the same soluble material as the material used to make the soluble core component 236. For example, the first mold component 200, the second mold component 218, and the soluble core component 236 can be made of polyvinyl alcohol. Alternatively, one or both of the first mold component 200 and the second mold component 218 can be made of a different soluble material than the material used to make the soluble core component 236.

In instances where both the first mold component 200 and the second mold component 218 are made of a soluble material, the method of forming the lens component (e.g., the haptic) can comprise immersing the entire assembled mold 250 in a solvent after the curing step. The entire assembled mold 250 can be immersed in the solvent to dissolve the soluble core component 236, the first mold component 200, and the second mold component 218. The method can also comprise heating the solvent to between about 35° C. and 55° C. and agitating the solvent by sonication or stirring to expedite the dissolution of the soluble core component 236, the first mold component 200, and the second mold component 218. In some embodiments, the soluble core component 236, the first mold component 200, and the second mold component 218 can be dissolved after being immersed in the solvent between about 6 hours to about 24 hours. What remains after all of the soluble material has dissolved is the molded lens component (for example, a haptic or optic portion having a cavity defined therein).

In some embodiments, either the first mold component 200 or the second mold component 218 (but not both) can be made of a soluble material. In these embodiments, the other mold component can be made of a non-soluble material. The non-soluble material can be a material not capable of dissolving within a solvent (e.g., water) in a practicable amount of time.

For example, either the first mold component 200 or the second mold component 218 can be made of the same soluble material as the material used to make the soluble core component 236. More specifically, in some embodiments, the first mold component 200 or the second mold component 218 and the soluble core component 236 can be made of polyvinyl alcohol. Alternatively, either the first mold component 200 or the second mold component 218 can be made of a different soluble material than the material used to make the soluble core component 236. The other mold component in these instances can be made of a non-soluble material. In some embodiments, the first mold component 200 can be made of polyvinyl alcohol and the second mold component 218 can be made from thermoplastic resins including polyolefins such as medium or high density polyethylene, polypropylene or copolymers thereof, poly-4-methylpentene, and polystyrene. The non-soluble mold component can also be made from polyacetal resins, polyacrylethers, polyarylether sulfones, different types of nylon including nylon 6, nylon 66 and nylon 11. Moreover, the non-soluble mold component can also be made of a corrosion-resistant metallic material such as stainless steel.

In instances where either the first mold component 200 or the second mold component 218 is made of a soluble material and the other mold component is made of a non-soluble material, the method of forming the lens component (e.g., the haptic) can comprise separating the two mold components after the curing step. At least a segment of the soluble core component 236 can be within the molded lens component or partially encapsulated by the molded lens component when the two mold components are separated. For example, the core body 238 of the soluble core component 236 can be within the molded lens component or partially encapsulated by the molded lens component when the molded lens component is removed from the first mold component 200 or the second mold component 218. Moreover, the positioning piece 240 of the soluble core component 236 can be connected to the molded lens component but not contained or encapsulated within the molded lens component.

The method can further comprise immersing the soluble mold component (either the first mold component 200 or the second mold component 218) along with the molded lens component in a solvent to dissolve the soluble core component 236 and the soluble mold component (either the first mold component 200 or the second mold component 218). The method can also comprise heating the solvent to between about 35° C. and 55° C. and agitating the solvent by sonication or stirring to expedite the dissolution of the soluble core component 236 and the soluble mold component. In some embodiments, the soluble core component 236 and the soluble mold component can be dissolved after being immersed in the solvent between about 6 hours to about 24 hours. What remains after all of the soluble material has dissolved is the molded lens component (for example, a haptic or optic portion having a cavity defined therein).

FIGS. 3A and 3B illustrate perspective views of embodiments of a soluble core component 236. The soluble core component 236 can comprise a curved or arcuate core body 238 connected to a positioning piece 240. In other embodiments not shown in the figures, the core body 238 can be substantially straight or shaped in an undulating or zig-zag manner.

As previously discussed, the positioning piece 240 can elevate or raise the core body 238 such that when the positioning piece 240 is placed on a flat surface, no portion of the core body 238 directly contacts the flat surface.

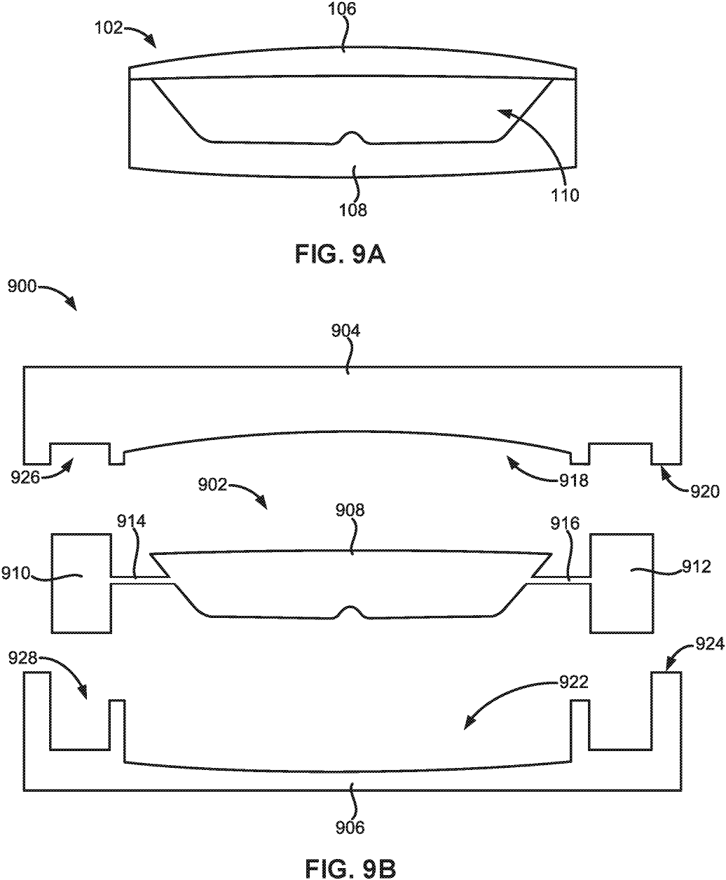

As shown in FIGS. 3A and 3B, the soluble core component 236 can have a core distal end 242 that is free and not attached to the positioning piece 240. In certain embodiments, the core distal end 242 can be rounded or curved. In other embodiments, the core distal end 242 can be flat, tapered, or pinched. As will be discussed in more detail in the following sections, in some embodiments, the soluble core component 236 can comprise two or more positioning pieces 240 and one or more core bodies 238 can extend in between such positioning pieces 240 (see, for example, FIG. 9B). In these embodiments, the soluble core component 236 does not comprise a free core distal end 242.

As previously discussed, the core body 238 of the soluble core component 236 can be disposed within a component mold cavity formed by the first partial component cavity 204 and the second partial component cavity 222 (see, for example, FIGS. 2A, 2B, and 2D) when the first mold component 200 is mated to the second mold component 218 to form the assembled mold 250. In this manner, the molded lens component (e.g., the haptic) can be formed around the core body 238 of the soluble core component 236.

The positioning piece 240 can be disposed within a positioning cavity formed by the first partial positioning cavity 206 and the second partial positioning cavity 224 (see, for example, FIGS. 2A, 2B, and 2D) when the first mold component 200 is mated to the second mold component 218 to form the assembled mold 250.

As shown in FIGS. 3A and 3B, the positioning piece 240 can comprise a first support wall 300, a second support wall 302, and a bridge component 304 connecting the first support wall 300 to the second support wall 302. The unique shape and design of the positioning piece 240 can allow a manufacturer to more easily remove the soluble core component 236 from a mold component using tweezers or other small plucking or grasping tools. The unique shape and design of the positioning piece 240 can also ensure that the positioning piece 240 does not deform or distort during the injection molding process.

The core body 238 can be connected to an exterior surface of the first support wall 300. The exterior surface of the first support wall 300 can be substantially flat to form a substantially flat optic attachment end (see, for example, the optic attachment end 136 of FIG. 1D) to allow the optic attachment end to more easily interface with a substantially flat protruding outer surface (see, for example, the protruding outer surface 134 of FIG. 1D) of a lens optic portion.

The first support wall 300 of the positioning piece 240 can also act as a barrier to separate the component mold cavity from the positioning cavity within the assembled mold 250. The first support wall 300 can prevent the lens component material within the component mold cavity from coming into contact with lens component material within the positioning cavity. In this manner, the first support wall 300 can serve as a temporary demarcation of the open end of the molded haptic.

The second support wall 302 of the positioning piece 240 can comprise one or more deformable or crushable protuberances 306 extending laterally from an exterior surface of the second support wall 302. The protuberances 306 can create gaps between the exterior surface of the second support wall 302 and the mold component walls defining the positioning cavity. These gaps can ensure the second support wall 302 (and, in turn, the positioning piece 240) does not become stuck or jammed within the positioning cavity. The gaps created by the protuberances 306 can allow a user to more easily remove the positioning piece 240 from either the first partial positioning cavity 206 or the second partial positioning cavity 224 when the first mold component 200 is separated from the second mold component 218.

FIGS. 3A and 3B also illustrate that a bridge component 304 can connect the first support wall 300 to the second support wall 302. The bridge component 304 can connect an inner surface of the first support wall 300 to an inner surface of the second support wall 302. The bridge component 304 can be raised or elevated such that passageways 308 or clearances are formed beneath and above the bridge component 304. In some embodiments, the passageways 308 can allow the low-viscosity lens component material to be injected or otherwise enter the interior of the assembled mold 250 through the passageways 308.

One technical problem faced by the applicants is how to use a soluble core alongside mold components to form lens components with complex inner shapes and geometries. One technical solution devised by the applicants is the soluble core component disclosed herein having a uniquely shaped positioning piece for positioning the soluble core component on a surface of the mold component. The positioning piece is also designed with structural features that complement the mold component and can provide passageways for a curable lens material to enter the component mold cavity.

Another technical problem faced by the applicants is how to prevent the first support wall 300 and the second support wall 302 of the positioning piece 240 from deforming during the injection molding process. One technical solution devised by the applicants is rather than designing the positioning piece 240 as a solid cube or cuboid-shaped structure, the applicants designed the positioning piece 240 having two support walls connected by a bridge component as shown and described herein. The two support walls can comprise rigid or non-deformable portions as well as crushable or deformable components extending from the support walls.

The soluble core component 236 can be made of a soluble or dissolvable material. As previously discussed, at least one of the first mold component 200 and the second mold component 218 can also be made of the same soluble or dissolvable material.

In some embodiments, the soluble core component 236, the first mold component 200, the second mold component 218, or a combination thereof can be made, in whole or in part, of a soluble vinyl alcohol homopolymer. For example, the soluble core component 236, the first mold component 200, the second mold component 218, or a combination thereof can be made, in whole or in part, of a soluble polyvinyl alcohol (PVOH). In some embodiments, the soluble core component 236, the first mold component 200, the second mold component 218, or a combination thereof can be made, in whole or in part, of a soluble polyvinyl alcohol comprising plasticizers. In certain embodiments, the soluble polyvinyl alcohol can comprise glycerol and other additives. More specifically, the soluble core component 236, the first mold component 200, the second mold component 218, or a combination thereof can be made, in whole or in part, of Mowiflex™C-30 or Mowiflex™C-600 distributed by Kuraray Europe GmbH.

In other embodiments, the soluble core component 236, the first mold component 200, the second mold component 218, or a combination thereof can be made, in whole or in part, of a butenediol vinyl alcohol (BVOH) co-polymer. The soluble core component 236, the first mold component 200, the second mold component 218, or a combination thereof can also be made, in whole or in part, of a soluble biodegradable material.

The soluble core component 236 can be completely dissolved when immersed in a solvent, such as water, between about 6 hours and 24 hours. The solvent can be heated to between about 35° C. to about 55° C. In other embodiments, the soluble core component 236 can be dissolved in a solvent kept at room temperature. The solvent can also be agitated by sonication to expedite the dissolution of the soluble core component 236. In other embodiments, the solvent can be agitated by stirring the solvent. For example, the soluble core component 236 can be immersed in a heated ultrasonic water bath to dissolve the soluble core component 236. In these and other embodiments, the first mold component 200, the second mold component 218, or a combination thereof can also be dissolved under similar conditions when such mold components are made of a soluble material.

In some embodiments, the entire soluble core component 236 including the positioning piece 240 and the core body 238 can be made of the same soluble material. In other embodiments, the positioning piece 240 or part of the positioning piece 240 can be made of a different soluble material than the core body 238.

Even though the soluble core component 236 is made of a soluble material. The soluble core component 236 can be cured into a substantially hardened or rigid component when used in the molding process. Moreover, when the first mold component 200, the second mold component 218, or a combination thereof are made of the soluble material, the mold component can be cured into a substantially hardened or rigid component when used in the molding process.

FIG. 3B illustrates that the soluble core component 236 can comprise a secondary core feature 310 protruding or extending out from the core body 238. As shown in FIG. 3B, the secondary core feature 310 can be a fin-shaped feature protruding from the radially inner body portion 244 of the core body 238.

The secondary core feature 310 can allow a lens designer to create additional cavities or passageways within a molded lens component. For example, the fin-shaped feature shown in FIG. 3B can be used to create a channel 500 extending into a radially inner portion of the haptic (see, for example, channel 500 of FIG. 5B).

FIG. 3B also illustrates that the core body 238 of the soluble core component 236 can comprise a core aperture 312. The core aperture 312 can be a hole or opening along the core body 238 that extends into at least part of the core body 238. As shown in FIG. 3B, the core aperture 312 can be located on the secondary core feature 310.

The core aperture 312 can receive a stabilizing member such as a stabilizing pin 708 (see, for example, FIG. 7) to keep the core body 238 in place during the molding process. For example, a stabilizing pin 708 can be inserted through the core aperture 312 to prevent the core body 238 from shifting or moving during the molding process (for example, when the lens component material is injected into the assembled mold 250 under vacuum).

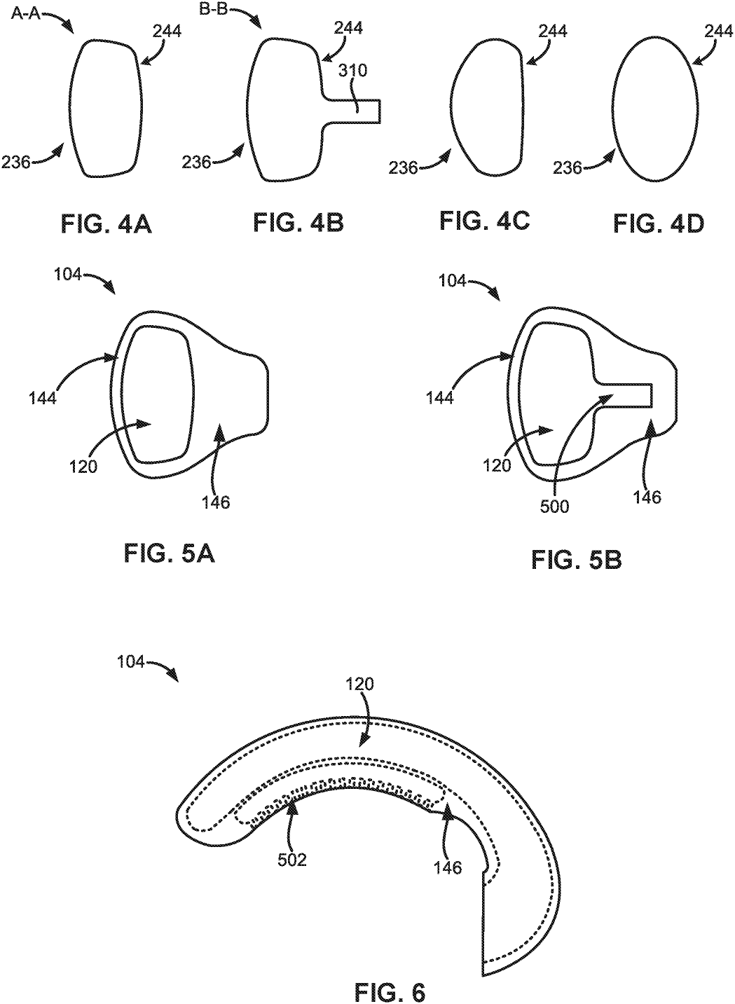

FIG. 4A illustrates a cross-sectional view of a core body 238 of the soluble core component shown in FIG. 3A taken along cross-section A-A. As shown in FIG. 4A, the core body 238 can have curved or rounded sides and sloped top and bottom sides. In further embodiments, either the top or bottom side can be substantially straight or horizontal.

FIG. 4B illustrates a cross-sectional view of a core body 238 of the soluble core component 236 shown in FIG. 3B taken along cross-section B-B. The core body 238 can have a secondary core feature 310 protruding or extending from the core body 238. As shown in FIG. 3B, the secondary core feature 310 can be a fin-shaped feature. Although FIG. 4B illustrates the secondary core feature 310 protruding from a vertically-centered region of the core body 238, it is contemplated by this disclosure that the secondary core feature 310 can also protrude from either the lower or upper region of the core body 238.

FIG. 4C illustrates a cross-sectional view of a core body 238 of another embodiment of the soluble core component 236. In this embodiment, the core body 238 can have a substantially D-shaped (or backwards D-shaped) cross-sectional profile.

FIG. 4D illustrates a cross-sectional view of a core body 238 of yet another embodiment of the soluble core component 236. In this embodiment, the core body 238 can have a substantially oval-shaped or ellipse-shaped cross-sectional profile.

FIG. 5A illustrates a cross-sectional view of an embodiment of a haptic 104 made using the soluble core component 236 shown in FIGS. 3A and 4A. Moreover, FIG. 5B illustrates a cross-sectional view of another embodiment of a haptic 104 made using the soluble core component 236 shown in FIGS. 3B and 4B. As shown in FIGS. 5A and 5B, a hollow haptic chamber 120 can be formed when the molded lens component is immersed in a solvent and the soluble core component 236 is dissolved in the solvent. The haptic chamber 120 can take on the shape of the core body 238 of the soluble core component 236.

FIG. 5B also illustrates that when the soluble core component 236 comprises a secondary core feature 310 (for example, a fin-shaped feature) protruding from the core body 238, an additional channel 500 can be formed that extends into the radially inner portion 146 of the haptic 104.

FIGS. 5A and 5B also illustrate that the positioning of the core body 238 within the component mold cavity can also affect the internal or cross-sectional shape or design of the haptic 104. For example, the core body 238 can be positioned closer to an outer edge or boundary of either the first molding surface 202 used to define the first partial component cavity 204 or the second molding surface 220 used to define the second partial component cavity 222 than an inner edge or boundary of such a surface. By doing so, the haptic 104 can be formed with a thicker radially inner portion 146 than a radially outer portion 144.

FIG. 6 illustrates a top plan view of an embodiment of a haptic 104 comprising interior cavity patterns made using one or more soluble core components 236. For example, a haptic 104 can be formed comprising a curved haptic chamber 120 and a comb-shaped cavity 502 positioned along a radially inner portion 146 of the haptic 104. These cavities can be created using multiple soluble core components 236 or a singular soluble core component 236 comprising comb-shaped protrusions or surface features.

FIG. 7 illustrates an exploded view of an embodiment of a system 700 for manufacturing a lens component (e.g., a haptic of an AIOL) comprising portions made of different curable materials. The system 100 can comprise a first mold component 200, a soluble core component 236, a second mold component 218, a third mold component 704, a stabilizing pin 708, a fourth mold component 712, and a clamping member 232. The first mold component 200 can be similar to the first mold component 200 previously described and shown in FIGS. 2A, 2D, and 2E. The soluble core component 236 can be similar to the soluble core component 236 previously described and shown in FIG. 3B.

The second mold component 218 of FIG. 7 can have an elongate opening 702 defined along the second molding surface 220. The elongate opening 702 can be positioned along at least part of the second partial component cavity 222. Part of the second partial component cavity 222 can be missing from the second mold component 218 due to the presence of the elongate opening 702. The elongate opening 702 can be aligned with mold features defined along the third mold component 704.

The second mold component 218 can also have a recessed portion 706 defined along a top side of the second mold component 218. The third mold component 704 can be placed or otherwise positioned within the recessed portion 706 In some embodiments, an initial step in forming an assembled mold using the components of the system 700 can comprise placing or inserting the third mold component 704 into the recessed portion 706 of the second mold component 218. When the third mold component 704 is placed within the recessed portion 706, the third mold component 704 can be detachably coupled to the second mold component 218 via an interference fit.

The soluble core component 236 can then be placed or pressed against the underside of the second mold component 218 comprising the second molding surface 220. For example, the positioning piece 240 of the soluble core component 236 can be pressed into the second partial positioning cavity 224 (not shown in FIG. 7) defined along the second molding surface 220 and the core body 238 of the soluble core component 236 can be positioned partly within the second partial component cavity 224 but not in physical with the second molding surface 220. The soluble core component 236 can be detachably coupled to the second mold component 218 via an interference fit when the positioning piece 240 is pressed or otherwise inserted into the second partial positioning cavity 224.

With the soluble core component 236 detachably coupled to the second mold component 218, a stabilizing pin 708 can be inserted through a core aperture 312 defined along the core body 238 or a secondary core feature 310 extending or protruding from the core body 238. The stabilizing pin 708 can be inserted through the core aperture 312 to prevent the core body 238 from shifting or moving during the molding process. For example, the stabilizing pin 708 can be made in part of a metallic material. The stabilizing pin 708 can have a diameter between about 0.5 mm to about 2.0 mm. The stabilizing pin 708 can be inserted into a receiving conduit or space defined along an underside of the third mold component 704.

The third mold component 704 can comprise a third molding surface (not shown in FIG. 7) with surface features, cavities, or a combination thereof defined along the third molding surface. For example, the third mold component 704 can be used to introduce negative space into parts of the molded lens component.

The second mold component 218 comprising the third mold component 704 and the soluble core component 236 can then be mated with the first mold component 200 to form a first assembled mold. The clamping member 232 can then be detachably fastened to the first mold component 200 to form an enclosed chamber. As shown in FIG. 7, the clamping member 232 (for example, a clamping cap) can have a septum 710 or opening defined along a top of the clamping member 232 to allow an injector nozzle to enter through the septum 710 or opening to deliver a first curable material, such as the lens component material previously discussed (e.g., the haptic material), into the enclosed chamber. For example, the first curable material can be injected or introduced into the reservoir space 214 of the first mold component 200.

The enclosed chamber comprising the clamping member 232 coupled to the first assembled mold can be cured to form a preliminary molded lens component. The clamping member 232 and the third mold component 704 can then be separated from the first mold component 200 and the second mold component 218. At this point, a fourth mold component 712 comprising a fourth molding surface can be placed or otherwise positioned within the recessed portion 706 of the second mold component 218. The fourth mold surface can comprise surface features and cavities that can be used to define the shape or positioning of additional portions of the molded lens component. The additional portions of the molded lens component can be made of a second curable material. The second curable material can be different than the first curable material (or the lens component material) used to make the preliminary molded lens component. In some embodiments, the second curable material can comprise a composite polymeric material comprising energy absorbing constituents and expandable components. For example, the second curable material can comprise expandable thermoplastic microspheres. As a more specific example, the second curable material can be the composite material described in U.S. Pat. App. No. 62/911,039, filed on Oct. 4, 2019, the contents of which are incorporated herein by reference. Once cured, the portions of the molded lens component made of the second curable material can expand in response to an external energy directed at such portions.

In some embodiments, the fourth mold component 712 can comprise openings or ports defined along the surface of the fourth mold component 712 to allow an injector nozzle or fluid delivery device to deliver the second curable material into cavities created by the fourth molding surface and the negative space defined along the preliminary molded lens. The same clamping member 232 or another clamping member 232 can then be detachably coupled to the first mold component 200 to form a second assembled mold. The second assembled mold can then be cured to form the molded lens component. This molded lens component comprising the soluble core component 236 or a combination of the molded lens component comprising the soluble core component 236 and any or all of the first mold component 200, the second mold component 218, and the fourth mold component 712 (depending on whether any of the mold components are made of the soluble material) can be immersed in the solvent to dissolve the soluble core component 236 or one or more of the mold components.

Although the system 700 shown in FIG. 7 includes four mold components (e.g., the first mold component 200, the second mold component 218, the third mold component 704, and the fourth mold component 712), it is contemplated by this disclosure that the system 700 can comprise more mold components including a fifth mold component, a sixth mold component, a seventh mold component, an eighth mold component, or nine or more mold components. These additional mold components can be used to form even more complex or elaborate molded lens components comprising different portions made of different curable materials, a plurality of interior chambers, or a combination thereof. For example, a variation of the system 700 shown in FIG. 7 can be used to form the haptic 104 shown in FIG. 6.

One technical problem faced by the applicants is how to form haptics comprising complex internal shapes and geometries such as uniquely shaped internal chambers surrounded by chamber walls of varying thicknesses. One technical solution devised by the applicants is to form the haptics using the soluble cores and molds disclosed herein. Moreover, the haptics formed using the soluble cores and molds disclosed herein can be coupled to an optic portion comprising an optic fluid chamber to form an AIOL that is optimized for placement within a subject’s capsular bag. The haptics formed using the soluble cores and molds disclosed herein can be adapted to deform in a specific manner due to the uniquely shaped chamber walls in response to ciliary muscle movement in connection with capsular bag reshaping. Deformation of the haptics can cause fluid within the haptic fluid chambers to enter into the optic fluid chamber to change the optical power of the AIOL. Haptic formed using the soluble cores and molds disclosed herein are well suited for such deformations.

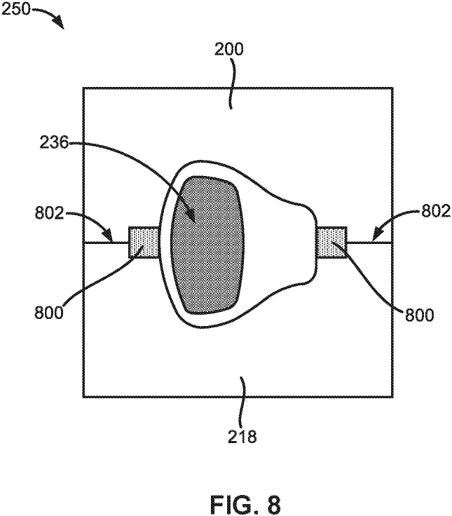

FIG. 8 illustrates a cross-sectional view of an embodiment of an assembled mold 250 comprising one or more soluble plugs 800 to prevent flash along one or more parting lines 802 between mold components. For example, the soluble plugs 800 can be inserted or otherwise positioned in between the first mold component 200 and the second mold component 218 prior to mating the two mold components together.

The one or more soluble plugs 800 can be placed within a first partial plug cavity defined along the first molding surface 202. The first partial plug cavity can be located or positioned along parting lines 802 between mold components (for example, the parting lines 802 between the first mold component 200 and the second mold component 218). The first partial plug cavity can be located or positioned at an interface region between the parting lines 802 and a boundary or start of the first partial component cavity 204. The first partial plug cavity can be connected to the first partial component cavity 204.

In some embodiments, the one or more soluble plugs 800 can be placed within a second partial plug cavity defined along the second molding surface 220. The second partial plug cavity can also be located or positioned along the parting lines 802 between mold components (for example, the parting lines 802 between the first mold component 200 and the second mold component 218). The second partial plug cavity can be located or positioned at an interface region between the parting lines 802 and a boundary or start of the first partial component cavity 204. The second partial plug cavity can be connected to the second partial component cavity 222.

The soluble plugs 800 can be made of a soluble material configured to be dissolved when immersed in a solvent. In some embodiments, the soluble plugs 800 can be made of the same soluble material as the soluble core component 236. In other embodiments, the soluble plugs 800 can be made of a different soluble material than the soluble material used to make the soluble core component 236.

The first partial plug cavity and the second partial plug cavity can form a plug receiving space when the first mold component 200 is mated to the second mold component 218 to form the assembled mold 250. The soluble plug can be configured to occupy the plug receiving space.

The assembled mold 250 comprising the soluble core component 236, the soluble plug 800, and the lens component material can be cured together. After the curing step, the molded lens component comprising the soluble core component 236 and the soluble plug 800 can be removed from either the first mold component 200 or the second mold component 218 and immersed in the solvent (e.g., water).

In embodiments where either the first mold component 200 or the second mold component 218 is also made of the soluble material, the mold component (either the first mold component 200 or the second mold component 218) made of the soluble material can also be immersed in the solvent to be dissolved.

Although the soluble plug 800 is represented as a block or nodule in the cross-sectional view of FIG. 8, it is contemplated by this disclosure and it should be understood by one of ordinary skill in the art that the soluble plug 800 can be implemented as an elongate cord or strand extending along the periphery of the first partial component cavity 204, the second partial component cavity 222, or a combination thereof.

The soluble plug 800 can act as a barrier or gasket to prevent the lens component material from seeping or leaking into any gaps created between mold components along the parting lines 802. The soluble plug 800 can be configured to prevent flash or surface imperfections along the periphery of the molded lens component.

One technical problem faced by the applicants is how to prevent flash from forming around the periphery of molded lens components made using separable mold components. One technical solution devised by the applicants is to place one or more soluble plugs along the periphery of the mold cavities. The soluble plugs can be made of the same soluble material as the soluble core component.

FIG. 9A illustrates an embodiment of an optic portion 102 of a fluid-filled AIOL. The optic portion 102 can comprise an anterior element 106, a posterior element 108, and an optic fluid chamber 110 defined therebetween.

The systems and methods disclosed herein can also be used to mold such an optic portion 102. For example, the optic fluid chamber 110 and a plurality of fluid channels (not shown in FIG. 9A, see fluid channels 122 of FIG. 1A) can be formed when a soluble core component 900 (see FIG. 9B) is dissolved within a solvent. In additional embodiments, the systems and methods disclosed herein can form part of the optic portion 102, such as the anterior element 106 or the posterior element 108. In these embodiments, at least part of the optic fluid chamber 110 can be formed when the soluble core component 900 is dissolved.

In some embodiments, the haptic(s) 104 formed by the soluble cores and molds disclosed herein can be adhered or otherwise coupled to the optic portion 102 formed by the soluble cores and molds disclosed herein using the adhesives disclosed in the preceding sections.

FIG. 9B illustrates a cross-sectional exploded view of a system 900 comprising alternative embodiments of a soluble core component 902, a first mold component 904, and a second mold component 906. The system 900 can be used to form the optic portion 102 shown in FIG. 9A comprising the optic fluid chamber 110. In other embodiments, modified versions of the soluble core component 902, the first mold component 904, and the second mold component 906 can be used to form at least part of the optic portion 102, such as the anterior element 106 or the posterior element 108.

The soluble core component 902 can comprise a core body 908, a plurality of positioning pieces including a first positioning piece 910 and a second positioning piece 912, a first set of connecting shafts 914 connecting the first positioning piece 910 to the core body 908, and a second set of connecting shafts 916 connecting the second positioning piece 912 to the core body 908.

The core body 908 can be shaped and sized to define the shape and size of the optic fluid chamber 110 (see FIG. 9A). The first set of connecting shafts 914 can comprise multiple connecting shafts connecting the core body 908 to the first positioning piece 910. The first set of connecting shafts 914 can be sized and shaped to define the size and shape of the first set of fluid channels 122A (see, for example, FIG. 1A) connecting the haptic fluid chamber 120 to the optic fluid chamber 110. In some embodiments, the first set of connecting shafts 914 can comprise two connecting shafts 914 connecting the core body 908 to the first positioning piece 910.

The second set of connecting shafts 916 can comprise multiple connecting shafts connecting the core body 908 to the second positioning piece 912. The second set of connecting shafts 916 can be sized and shaped to define the size and shape of the second set of fluid channels 122B (see, for example, FIG. 1A) connecting the optic fluid chamber 110 to another haptic fluid chamber 120. In some embodiments, the second set of connecting shafts 916 can comprise two connecting shafts 916 connecting the core body 908 to the second positioning piece 912. The optic fluid chamber 110 and the fluid channels 122 can be formed once the soluble core component 902 has been dissolved in the solvent.

As shown in FIG. 9B, the first mold component 904 can comprise a first partial component cavity 918 defined along a first molding surface 920. Moreover, the second mold component 906 can comprise a second partial component cavity 922 defined along a second molding surface 924. The first partial component cavity 918 and the second partial component cavity 922 can form a component mold cavity when the first mold component 904 is mated or otherwise coupled to the second mold component 906. The component mold cavity can be filled with a curable lens component material such as the lens body material disclosed in the preceding sections. The lens component material can be introduced into the component mold cavity via conduits, gates, or ports defined along the mold components.

The first molding component 904 can also have a plurality of first partial positioning cavities 926 defined along the first molding surface 920. The first partial positioning cavities 926 can be configured to accommodate or receive the plurality of positioning pieces of the soluble core component 902 including the first positioning piece 910 and the second positioning piece 912.

The second molding component 906 can also have a plurality of second partial positioning cavities 928 defined along the second molding surface 924. The second partial positioning cavities 928 can be configured to accommodate or receive the plurality of positioning pieces of the soluble core component 902 including the first positioning piece 910 and the second positioning piece 912.

In some embodiments, the first mold component 904, the second mold component 906, or a combination thereof can be made in part of the soluble material. In these and other embodiments, the first mold component 904, the second mold component 906, or a combination thereof can be made in part of the same soluble material as the soluble core component 908. In other embodiments, the first mold component 904, the second mold component 906, or a combination thereof can be made in part of a different soluble material than the soluble material used to make the soluble core component 908.

The molded lens component (e.g., the molded optic portion) comprising the soluble core component 908 can be immersed in a solvent (e.g., water) to dissolve the soluble core component 908. In some embodiments, the entire assembled mold can be immersed in the solvent or one of the mold components can be immersed in the solvent along with the molded lens component.

In further embodiments not shown in the figures but contemplated by this disclosure, soluble plugs 800 can also be placed around the periphery of the mold cavities to prevent flash from forming along a periphery of the molded lens component.

In certain embodiments, the optic portion 102 formed using the system 900 can be a one piece optic portion 102 comprising an anterior element 106 connected to the posterior element 108 without the use of adhesives. In other embodiments, parts of the system 900 or modified versions of the first mold component 904, the second mold component 906, and the soluble core component 908 can be used to form parts of the optic portion 102 including the anterior element 106 or the posterior element 108. In these embodiments, the molded anterior element 106 and the molded posterior element 108 can then be adhered or otherwise coupled together using the adhesives discussed in the preceding sections.

One technical problem faced by the applicants is how to form an optic portion of an AIOL comprising uniquely shaped fluid channels extending through parts of the optic portion. One technical solution devised by the applicants is to form the optic portion using the soluble cores and molds disclosed herein. Moreover, the optic portion formed using the soluble cores and molds disclosed herein can be coupled to haptics (also formed using soluble cores and molds, as disclosed herein) comprising haptic fluid chambers. The optic portion formed using the soluble cores and molds disclosed herein can be adapted to change shape (thereby changing the optic power of the AIOL) in response to fluid entering the optic fluid chamber from the haptic fluid chambers via the fluid channels and exiting the optic fluid chamber back into the haptic fluid chamber via the same fluid channels.

A number of embodiments have been described. Nevertheless, it will be understood by one of ordinary skill in the art that various changes and modifications can be made to this disclosure without departing from the spirit and scope of the embodiments. Elements of systems, devices, apparatus, and methods shown with any embodiment are exemplary for the specific embodiment and can be used in combination or otherwise on other embodiments within this disclosure. For example, the steps of any methods depicted in the figures or described in this disclosure do not require the particular order or sequential order shown or described to achieve the desired results. In addition, other steps operations may be provided, or steps or operations may be eliminated or omitted from the described methods or processes to achieve the desired results. Moreover, any components or parts of any apparatus or systems described in this disclosure or depicted in the figures may be removed, eliminated, or omitted to achieve the desired results. In addition, certain components or parts of the systems, devices, or apparatus shown or described herein have been omitted for the sake of succinctness and clarity.

Accordingly, other embodiments are within the scope of the following claims and the specification and/or drawings may be regarded in an illustrative rather than a restrictive sense.

Each of the individual variations or embodiments described and illustrated herein has discrete components and features which may be readily separated from or combined with the features of any of the other variations or embodiments. Modifications may be made to adapt a particular situation, material, composition of matter, process, process act(s) or step(s) to the objective(s), spirit or scope of the present invention.

Furthermore, where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this invention belongs.

1. A method of manufacturing a lens component, comprising:
providing a first mold component comprising a first molding surface defined by a first partial component cavity;
providing a second mold component comprising a second molding surface defined by a second partial component cavity;
placing at least part of a soluble core component on either the first molding surface or the second molding surface;
mating a second mold component to the first mold component to form an assembled mold, wherein a segment of the soluble core component is disposed within a mold cavity formed by the first partial component cavity and the second partial component cavity;
introducing a lens component material into the mold cavity;
curing the lens component material within the assembled mold to form a molded lens component; and
immersing the molded lens component in a solvent to dissolve the soluble core component.

2. The method of claim 1, wherein the soluble core component is made in part of polyvinyl alcohol.

3. The method of claim 1, wherein the solvent is water.

4. The method of claim 1, further comprising heating the solvent and agitating the solvent to expedite the dissolution of the soluble core component.

5. The method of claim 1, further comprising:
separating the first mold component from the second mold component after curing the lens component material to form the molded lens component; and
removing the molded lens component from the first mold component or the second mold component, wherein at least a segment of the soluble core component is within the molded lens component when the molded lens component is removed.

6. The method of claim 1, wherein placing at least part of the soluble core component on the first molding surface or the second molding surface comprises placing at least one positioning piece of the soluble core component on the first molding surface or the second molding surface, wherein the at least one positioning piece is at one end of the soluble core component, and wherein a portion of the soluble core component coupled to the at least one positioning piece is not in contact with the first molding surface or the second molding surface.

7. The method of claim 1, wherein placing the soluble core component on the first molding surface or the second molding surface comprises placing at least one positioning piece of the soluble core component on the first molding surface or the second molding surface, wherein the at least one positioning piece is at one end of the soluble core component, and wherein a remainder of the soluble core component coupled to the at least one positioning piece is not in contact with the first molding surface or the second molding surface.

8. The method of claim 1, wherein the first molding surface is further defined by a first partial plug cavity connected to the first partial component cavity, wherein the second molding surface is defined by a second partial plug cavity connected to the second partial component cavity, wherein the method further comprises:
placing a soluble plug within the first partial plug cavity or the second partial plug cavity prior to forming the assembled mold, wherein the soluble plug occupies a plug receiving space formed by the first partial plug cavity and the second partial plug cavity when the second mold component is mated to the first mold component; and
curing the lens component material within the assembled mold, wherein the assembled mold comprises the soluble plug.

9. The method of claim 1, wherein the lens component is a haptic of a lens and wherein a haptic chamber is formed within the haptic when the soluble core component is dissolved.

10. The method of claim 1, wherein the lens component is an optic portion of a lens and wherein an optic chamber is formed within the optic portion when the soluble core component is dissolved.

11. The method of claim 1, wherein the lens component is part of an optic portion of a lens and wherein at least part of an optic chamber is formed when the soluble core component is dissolved.

12. A system for manufacturing a lens component, comprising:
a first mold component comprising a first molding surface defined by a first partial component cavity;
a second mold component comprising a second molding surface defined by a second partial component cavity; and
a soluble core component configured to be placed on either the first molding surface or the second molding surface,
wherein the first mold component is configured to be mated to the second mold component to form an assembled mold,
wherein a segment of the soluble core component is configured to be disposed within a mold cavity formed by the first partial component cavity and the second partial component cavity when the first mold component is mated to the second mold component,
wherein the mold cavity within the assembled mold is configured to receive a lens component material for curing into a molded lens component, and
wherein the soluble core component is configured to be dissolved in a solvent when the molded lens component is immersed in the solvent.

13-22. .

23. A method of manufacturing a lens component, comprising:
providing a first mold component comprising a first molding surface defined by a first partial component cavity, wherein the first mold component is made of a soluble material;
providing a second mold component comprising a second molding surface defined by a second partial component cavity, wherein the second mold component is made of the soluble material;
placing at least part of a soluble core component on the first molding surface or the second molding surface, wherein the soluble core component is made of the soluble material;
mating the second mold component to the first mold component to form an assembled mold, wherein a segment of the soluble core component is disposed within a mold cavity formed by the first partial component cavity and the second partial component cavity;
introducing a lens component material into the mold cavity;
curing the lens component material within the assembled mold to form a molded lens component; and
immersing the assembled mold including the molded lens component in a solvent to dissolve the soluble core component, the first mold component, and the second mold component.

24-32. (canceled)

33. A system for manufacturing a lens component, comprising:
a first mold component comprising a first molding surface defined by a first partial component cavity, wherein the first mold component is made of a soluble material;
a second mold component comprising a second molding surface defined by a second partial component cavity, wherein the second mold component is made of the soluble material; and
a soluble core component configured to be placed on either the first molding surface or the second molding surface,
wherein the first mold component is configured to be mated to the second mold component to form an assembled mold,
wherein a segment of the soluble core component is configured to be disposed within a mold cavity formed by the first partial component cavity and the second partial component cavity when the first mold component is mated to the second mold component,
wherein the mold cavity within the assembled mold is configured to receive a lens component material for curing into a molded lens component, and
wherein the soluble core component, the first mold component, and the second mold component are configured to be dissolved in a solvent when the assembled mold is immersed in the solvent.

34-42. (canceled)

43. A method of manufacturing a lens component, comprising:
providing a first mold component comprising a first molding surface defined by a first partial component cavity, wherein the first mold component is made of a soluble material;
providing a second mold component comprising a second molding surface defined by a second partial component cavity;
placing at least part of a soluble core component on the first molding surface or the second molding surface, wherein the soluble core component is made of the soluble material;
mating a second mold component to the first mold component to form an assembled mold, wherein a segment of the soluble core component is disposed within a mold cavity formed by the first partial component cavity and the second partial component cavity;
introducing a lens component material into the mold cavity;
curing the lens component material within the assembled mold to form a molded lens component; and
immersing the first mold component and the molded lens component in a solvent to dissolve the first mold component and the soluble core component.

44-53. (canceled)

54. A system for manufacturing a lens component, comprising:
a first mold component comprising a first molding surface defined by a first partial component cavity, wherein the first mold component is made of a soluble material;
a second mold component comprising a second molding surface defined by a second partial component cavity; and
a soluble core component configured to be placed on the first molding surface or the second molding surface,
wherein the first mold component is configured to be mated to the second mold component to form an assembled mold,
wherein a segment of the soluble core component is configured to be disposed within a mold cavity formed by the first partial component cavity and the second partial component cavity when the first mold component is mated to the second mold component,
wherein the mold cavity within the assembled mold is configured to receive a lens component material for curing into a molded lens component, and
wherein the soluble core component and the first mold component are configured to be dissolved in a solvent when the first mold component and the molded lens component are immersed in the solvent.

55-64. (canceled)

65. The method of claim 1, further comprising securing the first mold component to the second mold component using a clamping member after mating the second mold component to the first mold component.

66. The method of claim 65, wherein the clamping member is a clamping cap configured to be detachably fastened to a top of the first mold component when the second mold component is mated to the first mold component.

67. The method of claim 1, wherein the second mold component comprises a vent configured to allow air to escape while the lens component material is introduced into the mold cavity.

68. The method of claim 1, wherein the lens component material is made in part of curable acrylic monomers.
